(19) United States
(12) Patent Application Publication
(10) Pub. No.: US 2012/0298433 A1
(43) Pub. Date: Nov. 29, 2012

(54) BATTERY MODULE, BATTERY SYSTEM, ELECTRIC VEHICLE, MOVABLE BODY, POWER STORAGE DEVICE, AND POWER SUPPLY DEVICE

(75) Inventor: Kazumi OHKURA, Nara-City (JP)

(73) Assignee: SANYO ELECTRIC CO., LTD., Moriguchi-City (JP)

(21) Appl. No.: 13/480,546

(22) Filed: May 25, 2012

(30) Foreign Application Priority Data
May 25, 2011 (JP) 2011-116669

(51) Int. Cl. H01M 10/50; B60L 11/18; H02J 7/00

(52) U.S. Cl. 180/65.1; 320/107; 429/120; 180/65.21; 903/907

(57) ABSTRACT

A plurality of separators are arranged to line up in an X-direction on a cooling plate to respectively correspond to a plurality of battery cells. The separators corresponding to the odd-numbered battery cells and the separators corresponding to the even-numbered battery cells are arranged in opposite directions in the X-direction. On a bottom surface portion of each of the separators, the corresponding battery cell is arranged. In this case, one side surface or the other side surface of each of the battery cells contacts a side surface portion of the corresponding separator, and a bottom surface of each of the battery cells contacts the bottom surface portion of the corresponding separator.

### BACKGROUND OF THE INVENTION

(1) Field of the Invention

The present invention relates to a battery module, and a battery system, an electric vehicle, a movable body, a power storage device, and a power supply device each including the battery module.

(2) Description of Related Art

Battery modules including a plurality of chargeable/dischargeable battery cells are used for movable bodies such as electric automobiles or power supply devices storing electric power. In such battery modules, the battery cells are cooled to suppress rises in temperatures of the battery cells.

For example, an automotive battery cooling system, which is discussed in JP 2008-159440 A, includes a plurality of battery cells, a side plate, and a cold plate. Each of the battery cells has a configuration in which a battery element is wrapped with an external film. The plurality of battery cells are respectively arranged so that a folded portion of the external film is grounded to an upper surface of the cold plate. In the state, the side plate fixes the plurality of battery cells to the cold plate. A refrigerant such as cooling water is caused to flow in the cold plate. Thus, each of the battery cells that contact the cold plate is cooled.

### BRIEF SUMMARY OF THE INVENTION

In JP 2008-159440 A, however, only one side of each of the battery cells contacts the cold plate. Therefore, a contact area between each of the battery cells and the cold plate is small. Therefore, each of the battery cells cannot be efficiently cooled.

An object of the present invention is to provide a battery module, a battery system, an electric vehicle, a movable body, a power storage device, and a power supply device that are capable of efficiently cooling each of battery cells.

According to an aspect of the present invention, a battery module includes a cooling member having a cooling surface for absorbing heat, a plurality of battery cells each having a first surface arranged on the cooling surface of the cooling member and having a second surface forming an angle to the first surface, and a thermal conduction member having a first thermal conduction plate and a second thermal conduction plate forming an angle to the first thermal conduction plate, in which the thermal conduction member is arranged so that the first thermal conduction plate directly or indirectly contacts the cooling surface of the cooling member and the second thermal conduction plate contacts the second surface of one of the battery cells. The first thermal conduction plate directly contacting the cooling surface of the cooling member means that the first thermal conduction plate contacts the cooling surface of the cooling member without via an interposition member, and the first thermal conduction plate indirectly contacting the cooling surface of the cooling member means that the first thermal conduction plate contacts the cooling surface of the cooling member via an interposition member. For example, a thermally conductive rubber or a thermally conductive adhesive for making the battery cell to adhere on the cooling surface of the cooling member is used as the interposition member.

In the battery module, the respective first surfaces of the plurality of battery cells are arranged on the cooling surface of the cooling member. The thermal conduction member is arranged so that the first thermal conduction plate directly or indirectly contacts the cooling surface of the cooling member and the second thermal conduction plate contacts the second surface of the one battery cell. The first surface and the second surface of the battery cell may be planar surfaces or curved surfaces.

Heat generated by the one battery cell is absorbed in the cooling surface of the cooling member via the second thermal conduction plate and the first thermal conduction plate from the second surface. In this case, the second surface of the battery cell contacts the second thermal conduction plate in the thermal conduction member. Therefore, a contact area between the battery cell and the thermal conduction member is large. Thus, heat is easily transmitted to the thermal conduction member from the battery cell. Since the first thermal conduction plate in the thermal conduction member directly or indirectly contacts the cooling surface of the cooling member, heat is easily transmitted to the cooling surface of the cooling member from the thermal conduction member. Therefore, each of the battery cells can be efficiently cooled.

Each of the plurality of battery cells may have a third surface different from the first and second surfaces, and the thermal conduction member may be arranged so that the second thermal conduction plate further contacts the third surface of the other battery cell adjacent to the one battery cell.

In this case, the second thermal conduction plate in the thermal conduction member contacts each of the second surface of the one battery cell and the third surface of the other battery cell. Thus, the two adjacent battery cells can be efficiently cooled while suppressing a space occupied by the thermal conduction member.

The first thermal conduction plate may have a first portion projecting toward one surface of the second thermal conduction plate and a second portion projecting toward the other surface of the second thermal conduction plate, and the thermal conduction member may be arranged so that the first portion of the first thermal conduction plate is positioned between the cooling surface of the cooling member and the first surface of the one battery cell.

In this case, the second thermal conduction plate in the thermal conduction member contacts the second surface of the one battery cell while the first portion of the first thermal conduction plate in the thermal conduction member is arranged between the cooling surface of the cooling member and the first surface of the one battery cell. Thus, heat is more easily transmitted to the thermal conduction member from the battery cell. Since the first and second portions of the first thermal conduction plate directly or indirectly contact the cooling surface of the cooling member, heat is more easily transmitted from the thermal conduction member to the cooling surface of the cooling member. Thus, each of the battery cells can be further efficiently cooled.

The battery module may further include a thermal insulation plate arranged between the adjacent battery cells and having lower thermal conductivity than that of the thermal conduction member.

In this case, even if the temperature of one of the adjacent battery cells rises, the thermal insulation plate inhibits heat from being conducted from the one battery cell to the other battery cell. Thus, chained thermal conduction among the plurality of battery cells is prevented.

The thermal insulation plate may be arranged to contact the second thermal conduction plate in the thermal conduction member.

In this case, heat from the thermal insulation plate is absorbed in the cooling surface of the cooling member via the thermal conduction member. Therefore, the rise in the temperature of the thermal insulation plate is suppressed. Thus, chained thermal conduction among the plurality of battery cells is more effectively prevented.

The thermal insulation plate may be arranged not to contact the second thermal conduction plate in the thermal conduction member.

In this case, the thermal insulation plate does not prevent contact between the second thermal conduction plate in the thermal conduction member and the other battery cell. Thus, each of the battery cells can be efficiently cooled while preventing chained thermal conduction among the plurality of battery cells.

According to another aspect of the present invention, a battery system includes one or a plurality of battery modules, in which at least one of the one or plurality of battery modules is the battery module according to the above-mentioned one aspect.

In the battery system, at least one of the one or plurality of battery modules is the above-mentioned battery module. Therefore, each of the battery cells can be efficiently cooled. Thus, the reliability of the battery system is improved.

According to still another aspect of the present invention, an electric vehicle includes the battery system according to the other aspect, a motor that is driven by electric power from the battery system, and a drive wheel that rotates by a torque generated by the motor.

In the electric vehicle, the motor is driven with the electric power from the battery system. The drive wheel rotates with the torque generated by the motor so that the electric vehicle moves. In this case, the above-mentioned battery system is used. Therefore, each of the battery cells can be more efficiently cooled. Therefore, the reliability of the electric vehicle is improved.

According to yet still another aspect of the present invention, a movable body includes the battery system according to the other aspect, a main body, a power source that converts electric power from the battery system into drive power, and a driver that moves the main body by the drive power obtained by the power source.

In the movable body, the power source converts the electric power from the battery system into the power, and the driver moves the main body with the power. In this case, the above-mentioned battery system is used. Thus, each of the battery cells can be efficiently cooled. Therefore, the reliability of the movable body is improved.

According to a further aspect of the present invention, a power storage device includes the battery system according to the other aspect, and a controller that performs control relating to discharge or charge of the plurality of battery cells in the battery system.

In the power storage device, the controller performs control relating to charge or discharge of the plurality of battery cells. Thus, the plurality of battery cells can be prevented from being degraded, overdischarged, and overcharged. Since the above-mentioned battery system is used, each of the battery cells can be efficiently cooled. Therefore, the reliability of the power storage device is improved.

According to a still further aspect of the present invention, a power supply device that is connectable to an external object includes the power storage device according to the other aspect, and a power conversion device that is controlled by the controller in the power storage device and converts electric power between the battery system in the power storage device and the external object.

In the power supply device, the power conversion device performs electric power conversion between the plurality of battery cells and the external object. The controller in the power storage device controls the power conversion device so that control relating to charge or discharge of the plurality of battery cells is performed. Thus, the plurality of battery cells can be prevented from being degraded, overdischarged, and overcharged. Since the above-mentioned battery system is used, each of the battery cells can be efficiently cooled. Therefore, the reliability of the power supply device is improved.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is an external perspective view of a battery module according to the present embodiment;

FIG. 2 is a plan view of the battery module illustrated in FIG. 1;

FIG. 3 is an external perspective view of a separator;

FIG. 4 is an external perspective view of a separator;

FIG. 5 is a schematic side view illustrating a first arrangement example of separators;

FIG. 6 is a schematic side view illustrating a second arrangement example of separators;

FIG. 7 is a schematic side view illustrating a third arrangement example of separators;

FIG. 8 is a schematic side view illustrating a fourth arrangement example of separators;

FIG. 9 is a schematic side view illustrating a fifth arrangement example of separators;

FIG. 10 is a schematic side view illustrating a sixth arrangement example of separators;

FIG. 11 is an external perspective view illustrating another example of a separator;

FIG. 12 is a schematic side view illustrating an arrangement example of the separators illustrated in FIG. 10;

FIG. 13 is a schematic side view illustrating another example of a cooling plate;

FIG. 14 is a plan view illustrating an example of a bus bar used in the present embodiment;

FIG. 15 is a schematic plan view illustrating bus bars that remain attached to a plurality of battery cells;

FIGS. 16 (a), 16 (b) and 16 (c) are schematic plan views each illustrating other examples of a bus bar;

FIG. 17 is a schematic plan view illustrating another arrangement example of a plus electrode and a minus electrode of each of battery cells;

FIG. 18 is a schematic plan view illustrating a configuration of a battery system according to a second embodiment;

FIG. 19 is a schematic view for illustrating a circulation system of a refrigerant in the battery system;

FIG. 20 is a block diagram illustrating a configuration of an electric automobile according to a third embodiment; and

FIG. 21 is a block diagram illustrating a configuration of a power supply device according to a fourth embodiment.

### DESCRIPTION OF THE PREFERRED EMBODIMENTS

A battery module, a battery system, an electric vehicle, a movable body, an electric storage device, and a power supply device according to an embodiment of the present invention will be described with reference to the drawings.

### (1) First Embodiment

A battery module according to a first embodiment of the present invention will be described.

(1-1) Overall Configuration

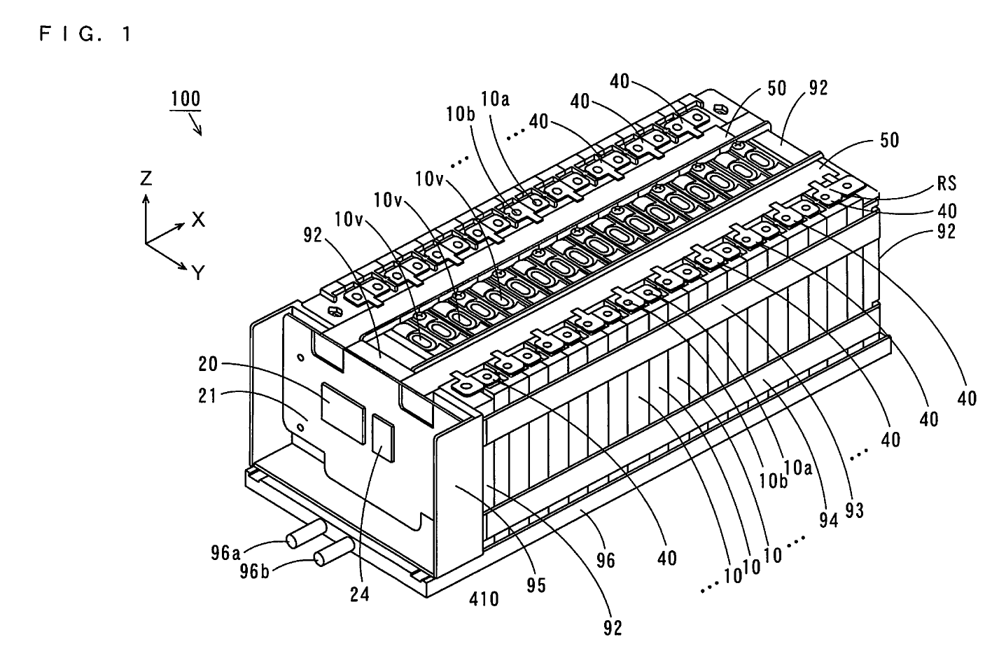

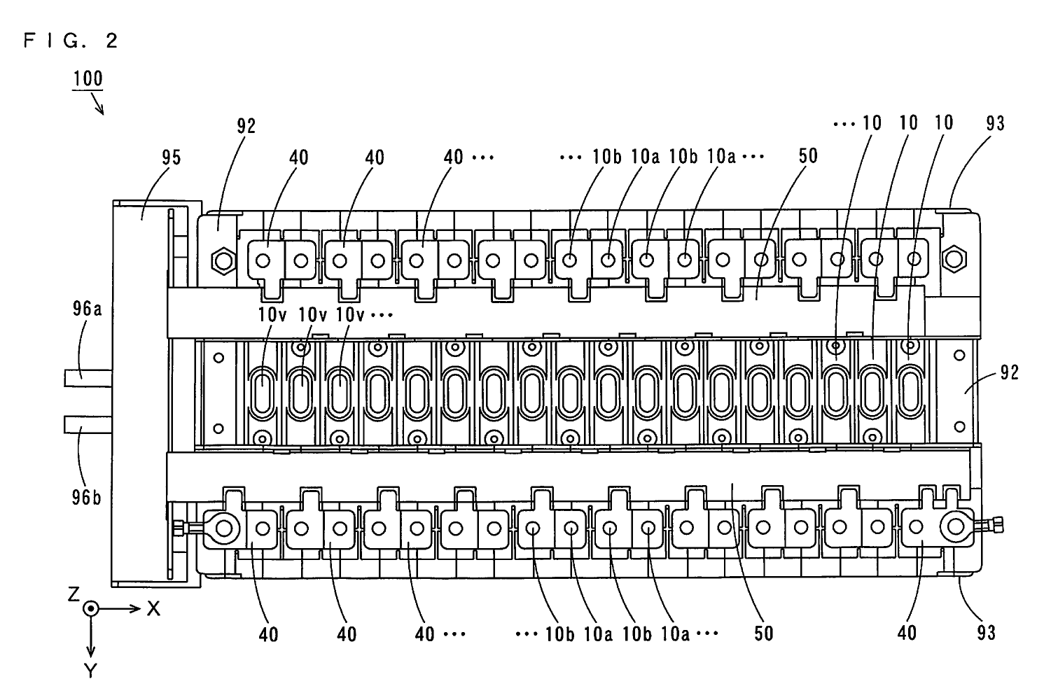

FIG. 1 is an external perspective view of a battery module 100 according to the present invention, and FIG. 2 is a plan view of the battery module 100 illustrated in FIG. 1. In FIGS. 1 and 2, and FIGS. 5 to 10, 12, 13, 15 and 17, described below, three directions that are perpendicular to one another are respectively defined as an X-direction, a Y-direction, and a Z-direction, as indicated by arrows X, Y and Z. In this example, the X-direction and the Y-direction are parallel to a horizontal plane, and the Z-direction is perpendicular to the horizontal plane.

As illustrated in FIGS. 1 and 2, in the battery module 100, a plurality of (18 in this example) battery cells 10 line up in the X-direction. The shape of the battery cell 10 is not particularly limited. The battery cell 10 may have a cross section of a trapezoid, a parallelogram, or a wedge shape. Alternatively, the battery cell 10 may be in a columnar shape or of a laminate type. In this example, the battery cell 10 has a flat and substantially rectangular parallelepiped shape. The pair of end plates 92 has a substantially plate shape, and is arranged parallel to a Y-Z plane. A pair of upper end frames 93 and a pair of lower end frames 94 are arranged to extend in the X-direction.

Connection portions for connecting the pair of upper end frames 93 and the pair of lower end frames 94 are respectively formed at four corners of the pair of end plates 92. With the plurality of battery cells 10 arranged between the end plates 92, the pair of upper end frames 93 is attached to the connection portions on the upper side of the pair of end plates 92, and the pair of lower end frames 94 is attached to the connection portions on the lower side of the pair of end plate 92. Thus, the plurality of battery cells 10 are integrally fixed while lining up in the X-direction.

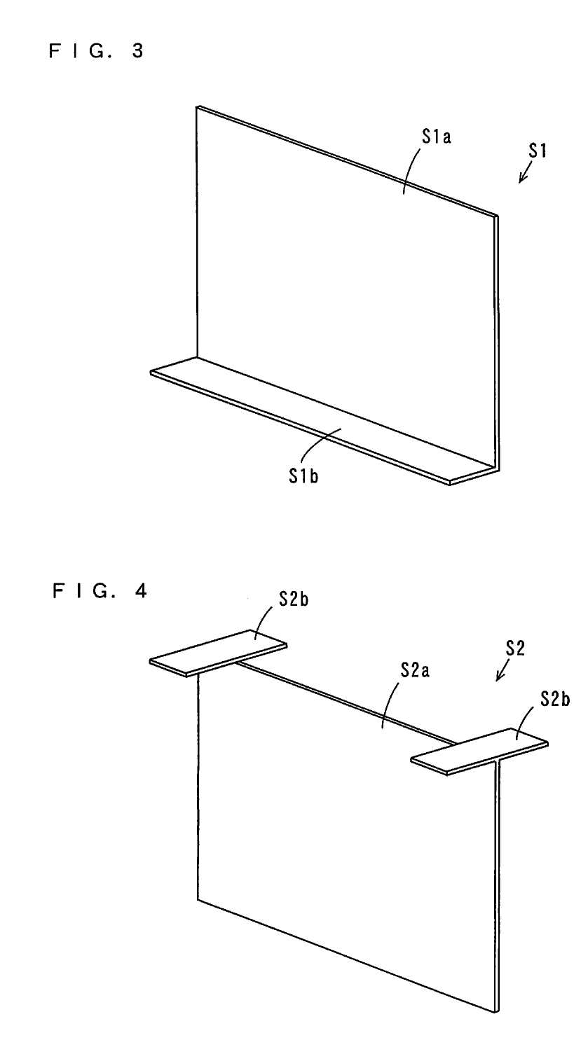

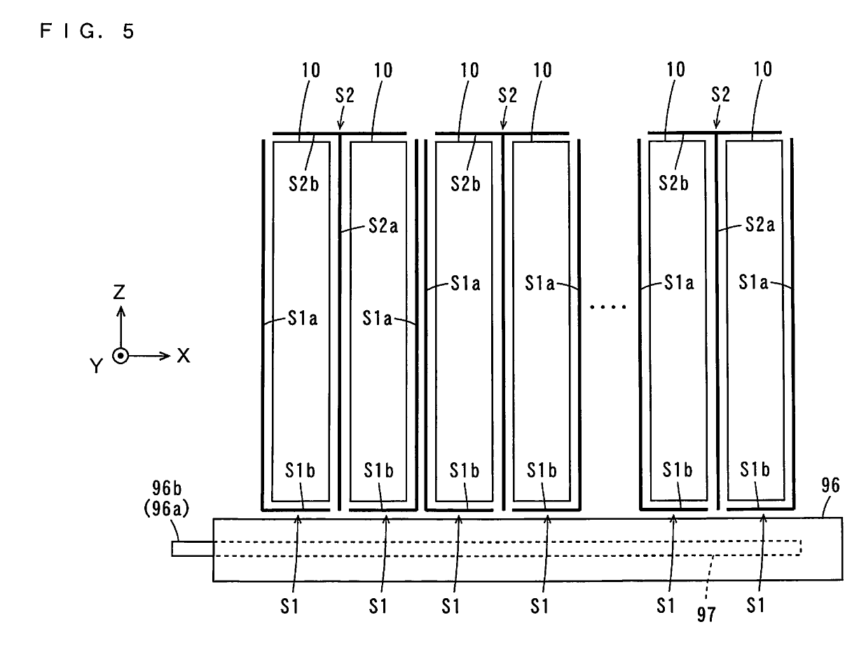

In the present embodiment, at least one of separators S1 and S2 (FIGS. 3 and 4, described below) is arranged between the adjacent battery cells 10. The separator S1 is an example of a thermal conduction member, and the separator S2 is an example of a thermal insulation plate. A configuration and an arrangement of the separators S1 and S2 will be described below.

A rigid printed circuit board (hereinafter abbreviated as a printed circuit board) 21 is attached to one of the end plates 92. A protection member 95 having a pair of side surface portions and a bottom surface portion is attached to the end plate 92 to protect both ends and the bottom of the printed circuit board 21. The protection member 95 protects the printed circuit board 21. A detection circuit 20 and a communication circuit 24 are mounted on the printed circuit board 21.

The plurality of battery cells 10 are arranged on a cooling plate 96. The cooling plate 96 includes a refrigerant inlet 96a and a refrigerant outlet 96b. A refrigerant path 97 (see FIG. 5, described below) that communicates with the refrigerant inlet 96a and the refrigerant outlet 96b is formed within the cooling plate 96. When a refrigerant such as cooling water flows into the refrigerant inlet 96a, the refrigerant passes through the refrigerant path 97 within the cooling plate 96 and flows out of the refrigerant outlet 96b. Thus, the cooling plate 96 is cooled. The cooling plate 96 is an example of a cooling member, and an upper surface of the cooling plate 96 is an example of a cooling surface. Heat generated by the plurality of battery cells 10 is absorbed in the upper surface of the cooling plate 96 via the separator S1, described below.

The plurality of battery cells 10 each have a plus electrode 10a arranged on an upper surface portion on one end side or the other end side in the Y-direction, and have a minus electrode 10b arranged on an upper surface portion on the opposite side. Each of the electrodes 10a and 10b projects upward.

Each of the battery cells 10 has a gas vent valve 10v at the center of its upper surface. When internal pressure of the battery cell 10 rises to a predetermined value, gas in the battery cell 10 is discharged through the gas vent valve 10v. This prevents the rise in the internal pressure of the battery cell 10.

In the following description, the battery cell 10 adjacent to one of the end plates 92 (the end plate 92 to which the printed circuit board 21 is not attached) to the battery cell 10 adjacent to the other end plate 92 (the end plate 92 to which the printed circuit board 21 is attached) are referred to as first to M-th battery cells 10. M is a natural number not less than 2, and is 18 in an example illustrated in FIGS. 1 and 2.

As illustrated in FIG. 2, the battery cells 10 are arranged so that respective positional relationships between the plus electrodes 10a and the minus electrodes 10b in the Y-direction in the adjacent battery cells 10 are opposite to each other. Thus, between the two adjacent battery cells 10, the plus electrode 10a of one of the battery cells 10 and the minus electrode 10b of the other battery cell 10 are in close proximity to each other, and the minus electrode 10b of one of the battery cells 10 and the plus electrode 10a of the other battery cell 10 are in close proximity to each other. In this state, the bus bar 40 composed of a metal plate is attached to the two electrodes 10a and 10b in close proximity to each other. Thus, the plurality of battery cells 10 are connected in series.

More specifically, the common bus bar 40 is attached to the minus electrode 10b of the first battery cell 10 and the plus electrode 10a of the second battery cell 10. The common bus bar 40 is attached to the minus electrode 10b of the second battery cell 10 and the plus electrode 10a of the third battery cell 10.

Similarly, the common bus bar 40 is attached to the minus electrode 10b of each of the odd-numbered battery cells 10 and the plus electrode 10a of the adjacent even-numbered battery cell 10. The common bus bar 40 is attached to the minus electrode 10b of each of the even-numbered battery cells 10 and the plus electrode 10a of the adjacent odd-numbered battery cell 10.

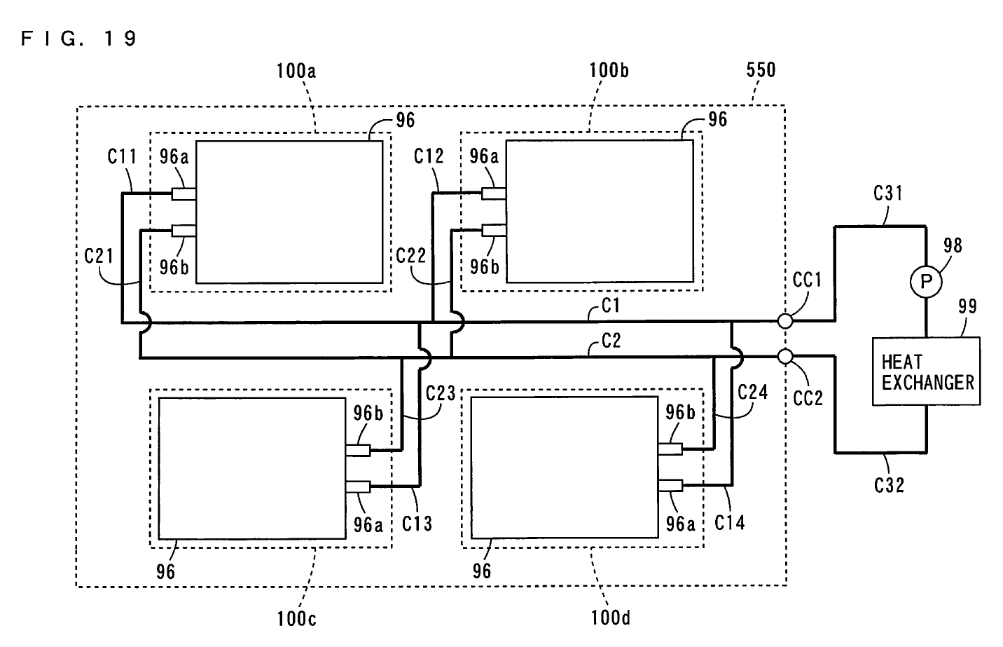

On the other hand, the bus bars 40 for externally connecting electric power lines D1 to D6 (see FIG. 18, described below) are respectively attached to the plus electrode 10a of the first battery cell 10 and the minus electrode 10b of the M-th battery cell 10.

Thus, the plurality of bus bars 40 are arranged in two rows in the X-direction on the plurality of battery cells 10. Long-sized two flexible printed circuit boards (hereinafter abbreviated as FPC boards) 50 extending in the X-direction are arranged inside the two rows of the plurality of bus bars 40.

One of the FPC boards 50 is arranged between the gas vent valves 10v of the plurality of battery cells 10 and the one row of the plurality of bus bars 40 not to overlap the gas vent valves 10v of the plurality of battery cells 10. Similarly, the other FPC board 50 is arranged between the gas vent valves 10v of the plurality of battery cells 10 and the other row of the plurality of bus bars 40 not to overlap the gas vent valves 10v of the plurality of battery cells 10.

The one FPC board 50 is connected in common to the one row of the plurality of bus bars 40. Similarly, the other FPC board 50 is connected in common to the other row of the plurality of bus bars 40. Each of the FPC boards 50 is bent downward at an upper end portion of one of the end plates 92 to be connected to the printed circuit board 21. Each of the plurality of bus bars 40 is electrically connected to the printed circuit board 21 via the two FPC boards 50. The detection circuit 20 on the printed circuit board 21 detects a terminal voltage of each of the battery cells 10.

(1-2) Separator

In the present embodiment, at least one of the separators S1 and S2 is arranged between the adjacent battery cells 10. Details of the separators S1 and S2 will be described below. FIG. 3 is an external perspective view of the separator S1, and FIG. 4 is an external perspective view of the separator S2.

In the following description, a pair of surfaces parallel to a Y-Z plane of each of the battery cells 10 is referred to as a pair of side surfaces. Particularly, one, close to the end plate 92 to which the printed circuit board 21 is not attached, of the pair of side surfaces of each of the battery cells 10 is referred to as one side surface, and one, close to the end plate 92 to which the printed circuit board 21 is attached, of the pair of side surfaces is referred to as the other side surface. The one side surface of the one battery cell 10 and the other side surface of the other battery cell 10 adjacent to the battery cell 10 are opposite to each other. A pair of surfaces parallel to an X-Y plane of each of the battery cells 10 is referred to as an upper surface and a bottom surface. A bottom surface of the battery cell 10 is an example of a first surface, and the one side surface and the other side surface of the battery cell 10 are respectively referred to as a second surface and a third surface. The odd-numbered battery cells 10 are referred to as (2k−1)-th battery cells 10, and the even-numbered battery cells 10 are referred to as 2k-th battery cells 10, as needed, where k is any natural number of one or more.

As illustrated in FIG. 3, the separator S1 includes a rectangular plate-shaped side surface portion S1a, and includes a bottom surface portion S1b integrally provided therein to form an angle to the side surface portion S1a and project by a predetermined width toward one surface of the side surface portion S1a from a lower end of the side surface portion S1a. In this example, the bottom surface portion S1b is perpendicular to the side surface portion S1a. The bottom surface portion S1b is an example of a first thermal conduction plate, and the side surface portion S1a is an example of a second thermal conduction plate. The area of the side surface portion S1a is substantially equal to the area of the one side surface of the battery cell 10. The separator S1 is formed of a material having high thermal conductivity, such as aluminum or copper. The separator S1 preferably has an electrical insulation property to ensure an electrical insulation property other than that between the electrodes 10a and 10b of the adjacent battery cells 10. For example, the separator S1 has an electrical insulation property by subjecting a surface of the separator S1 to alumite processing. If a surface of each of the battery cells 10 has been subjected to electrical insulation processing, the separator S1 need not have an electrical insulation property.

As illustrated in FIG. 4, the separator S2 includes a rectangular plate-shaped side surface portion S2a, and includes a pair of projections S2b integrally provided therein to form an angle to the side surface portion S2a and project toward one surface and the other surface of the side surface portion S2a from an upper end of the side surface portion S2a. In this example, the projection portions S2b are perpendicular to the side surface portion S2a. The projection portion S2b may be provided with a hole, a groove, or a notch so that the electrodes 10a and 10b and the gas vent valve 10v of the battery cell 10, and the bus bar 40 are not covered with the projection portion S2b. The area of the side surface portion S2a is substantially equal to the area of the one side surface of the battery cell 10. The thickness of the side surface portion S2a may be the same as or different from the thickness of the side surface portion S1a. The separator S2 is formed of a material having low thermal conductivity, for example, resin. The separator S2 has lower thermal conductivity than the separator S1. The separator S2 preferably has an electrical insulation property, similarly to the separator S1. If the surface of each of the battery cells 10 is subjected to electrical insulation processing, the separator S2 need not have an electrical insulation property.

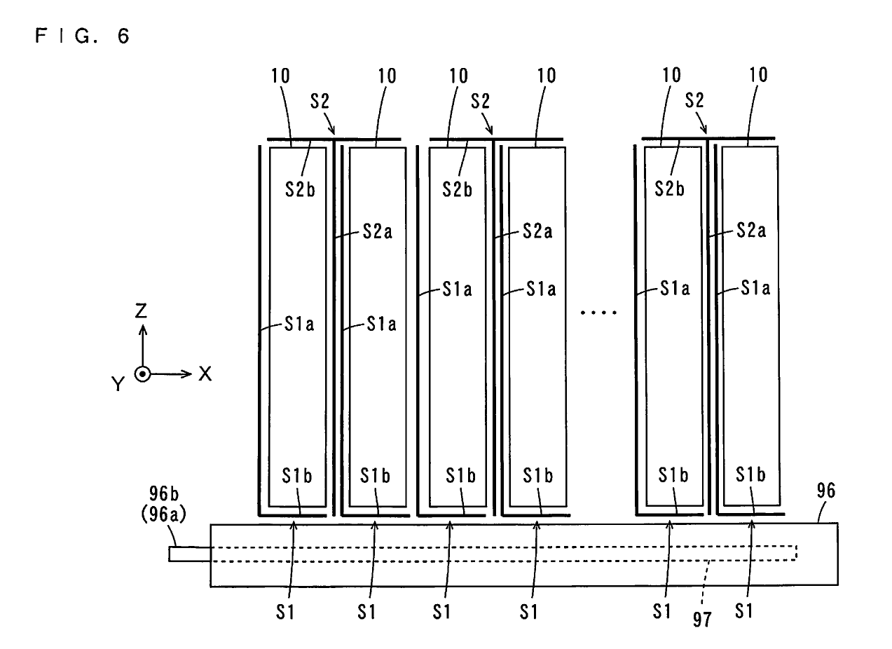

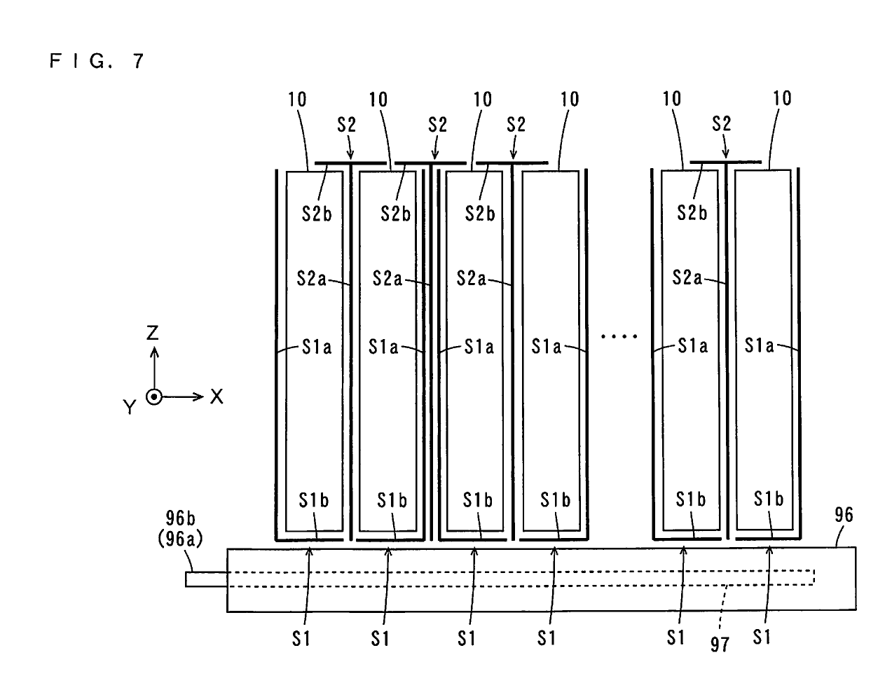

FIG. 5 is a schematic side view illustrating a first arrangement example of the separators S1 and S2. In FIG. 5, and FIGS. 6 to 10, 12 and 13, described below, illustration of the end plates 92, the pair of upper end frames 93, and the pair of lower end frames 94 is omitted. In the example illustrated in FIG. 5, a plurality of separators S1 are arranged to line up in the X-direction on the cooling plate 96 to respectively correspond to the plurality of battery cells 10. Each of the separators S1 is arranged so that the bottom surface portion S1b overlaps the upper surface of the cooling plate 96. The separator S1 corresponding to the odd-numbered battery cell 10 and the separator S1 corresponding to the even-numbered battery cell 10 are arranged opposite to each other in the X-direction.

On the bottom surface portion S1b in each of the separators S1, the corresponding battery cell 10 is arranged. In this case, the bottom surface portion S1b in each of the separators S1 is arranged between the upper surface of the cooling plate 96 and the bottom surface of the corresponding battery cell 10. The bottom surface portion S1b in each of the separators S1 contacts the bottom surface of the corresponding battery cell 10 while contacting the upper surface of the cooling plate 96. An interposition member such as a thermally conductive rubber or a thermally conductive adhesive for making the battery cell 10 to adhere on the cooling plate 96 may be arranged at least between the bottom surface portion S1b in the separator S1 and the bottom surface of the battery cell 10 and between the bottom surface portion S1b in the separator S1 and the upper surface of the cooling plate 96.

In this example, the two battery cells 10, i.e., the (2k−1)-th and 2k-th battery cells 10, which are adjacent to each other, constitute a battery cell pair. One side surface of the (2k−1)-th battery cell 10 in each of the battery cell pairs contacts the side surface portion S1a in the corresponding separator S1, and the other side surface of the 2k-th battery cell in the battery cell pair contacts the side surface portion S1 in the corresponding separator S1.

The side surface portion S2a in the separator S2 is arranged between the other side surface of the (2k−1)-th battery cell 10 and the one side surface of the 2k-th battery cell 10 in each of the battery cell pairs. The projection portions S2b in each of the separators S2 are respectively arranged to overlap the upper surfaces of the two battery cells 10 in the corresponding battery cell pair. The other side surface of the (2k−1)-th battery cell 10 in each of the battery cell pairs contacts the side surface portion S2a in the corresponding separator S2, and the one side surface of the 2k-th battery cell 10 contacts the side surface portion S2a in the corresponding separator S2.

(1-3) Effects

In the battery module 100 according to the present embodiment, the separator S1 having high thermal conductivity corresponds to each of the battery cells 10. Heat generated from each of the battery cells 10 is transmitted to the cooling plate 96 via the corresponding separator S1, and is absorbed in a refrigerant flowing through the refrigerant path 97 in the cooling plate 96. In this case, the one side surface or the other side surface of each of the battery cells 10 contacts the side surface portion S1a in the corresponding separator S1, and the bottom surface of each of the battery cells 10 contacts the bottom surface portion S1b in the corresponding separator S1. Thus, a contact area between each of the battery cells 10 and the corresponding separator S1 is large. Thus, heat generated from each of the battery cells 10 is easily transmitted to the separator S1. Since the bottom surface portion S1b in the separator S1 contacts the upper surface of the cooling plate 96, heat is easily transmitted to the cooling plate 96 from the separator S1. As a result, each of the battery cells 10 can be efficiently cooled.

The side surface portion S2a in the separator S2 having low thermal conductivity is arranged between the two battery cells 10 in the corresponding battery cell pair. Thus, the separator S2 suppresses thermal conduction between the two battery cells 10 in the corresponding battery cell pair. Even if the temperature of one of the battery cells 10 in each of the battery cell pairs rises, therefore, heat can be prevented from being conducted from the one battery cell 10 to the other battery cell 10. As a result, chained thermal conduction between the plurality of battery cells 10 is prevented.

(1-4) Another Arrangement Example of Separator

(1-4-1) Second Arrangement Example

FIG. 6 is a schematic side view illustrating a second arrangement example of the separators S1 and S2. The example illustrated in FIG. 6 will be described by referring to differences from the example illustrated in FIG. 5. In the example illustrated in FIG. 6, all the separators S1 are arranged in the same direction. In this case, the other side surface of each of the battery cells 10 contacts the side surface portion S1a in the corresponding separator S1.

The side surface portion S2a in the separator S2 is arranged between the side surface portion S1a in the separator S1 corresponding to the (2k−1)-th battery cell 10 in each of the battery cell pairs and one side surface of the 2k-th battery cell 10 in the battery cell pair. Thus, the one side surface of the 2k-th battery cell 10 in each of the battery cell pairs contacts the side surface portion S2a in the separator S2. The other side surface of the (2k−1)-th battery cell 10 in each of the battery cell pairs, excluding the first battery cell 10, contacts the side surface portion S1a in the separator S1 corresponding to the adjacent (2k−2)-th battery cell.

In this example, both side surfaces of one of the battery cells 10 in each of the battery cell pairs respectively contact the side surface portions S1a in the separators S1 corresponding to the battery cell pair. Thus, one of the battery cells 10 in each of the battery cell pairs is more sufficiently cooled. The side surface portion S2a in the separator S2 is arranged to contact the side surface portion S1a in the separator S1 between the one and other battery cells 10 in each of the battery cell pairs. Thus, the separator S2 suppresses thermal conduction between the two battery cells 10 in each of the battery cell pairs while the separator S1 suppresses the rise in the temperature of the separator S2. As a result, chained thermal conduction between the plurality of battery cells 10 is more effectively prevented.

(1-4-2) Third Arrangement Example

FIG. 7 is a schematic side view illustrating a third arrangement example of the separators S1 and S2. The example illustrated in FIG. 7 will be described by referring to differences from the example illustrated in FIG. 5. In the example illustrated in FIG. 7, the side surface portion S2a in the separator S2 is arranged between the side surface portion S1a in the separator S1 corresponding to the 2k-th battery cell 10 in each of battery cell pairs and the side surface portion S1a in the separator S1 corresponding to the adjacent (2k+1)-th battery cell 10 in addition to the configuration illustrated in FIG. 5.

In this example, the side surface portion S2a in the separator S2 is arranged to be sandwiched between the side surface portions S1a in the two separators S2 between the adjacent battery cell pairs. Thus, the separator S2 suppresses thermal conduction between the adjacent battery cell pairs while the separator S1 suppresses the rise in the temperature of the separator S2 between the adjacent battery cell pairs. As a result, chained thermal conduction between the plurality of battery cells 10 is more effectively prevented.

(1-4-3) Fourth Arrangement Example

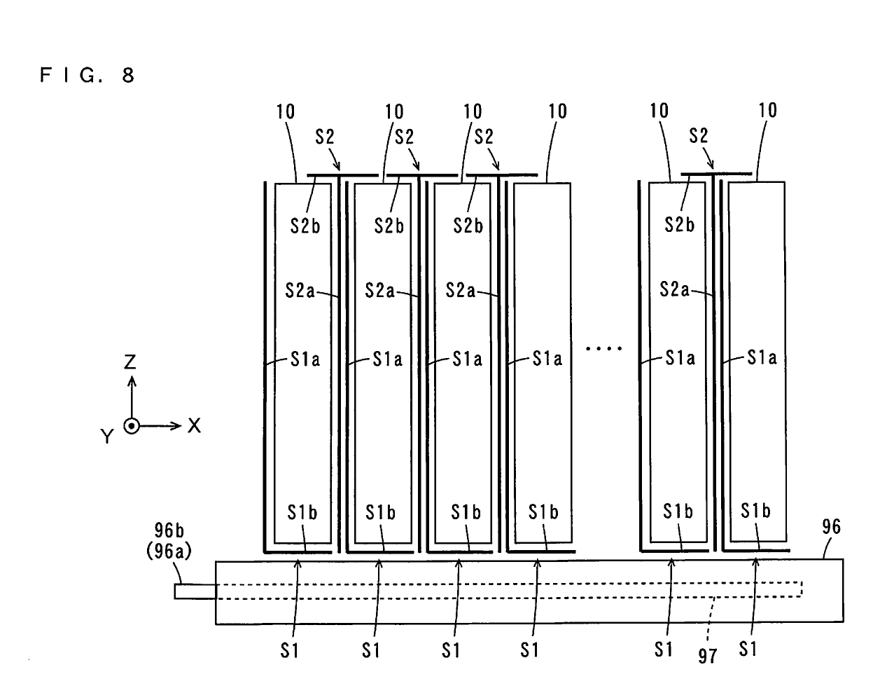

FIG. 8 is a schematic side view illustrating a fourth arrangement example of the separators S1 and S2. The example illustrated in FIG. 8 will be described by referring to differences from the example illustrated in FIG. 6. In the example illustrated in FIG. 8, the side surface portion S2a in the separator S2 is arranged between the side surface portion S1a in the separator S1 corresponding to the 2k-th battery cell 10 in each of battery cell pairs and one side surface of the adjacent (2k+1)-th battery cell 10 in addition to the configuration illustrated in FIG. 6. In this example, the side surface portion S2a in the separator S2 is arranged to contact the side surface portion S1a in the separator S1 between the adjacent battery cell pairs. Thus, the separator S2 suppresses thermal conduction between the adjacent battery cell pairs while the separator S1 suppresses the rise in the temperature of the separator S2 between the adjacent battery cell pairs. As a result, chained thermal conduction between the plurality of battery cells 10 is more effectively prevented.

(1-4-4) Fifth Arrangement Example

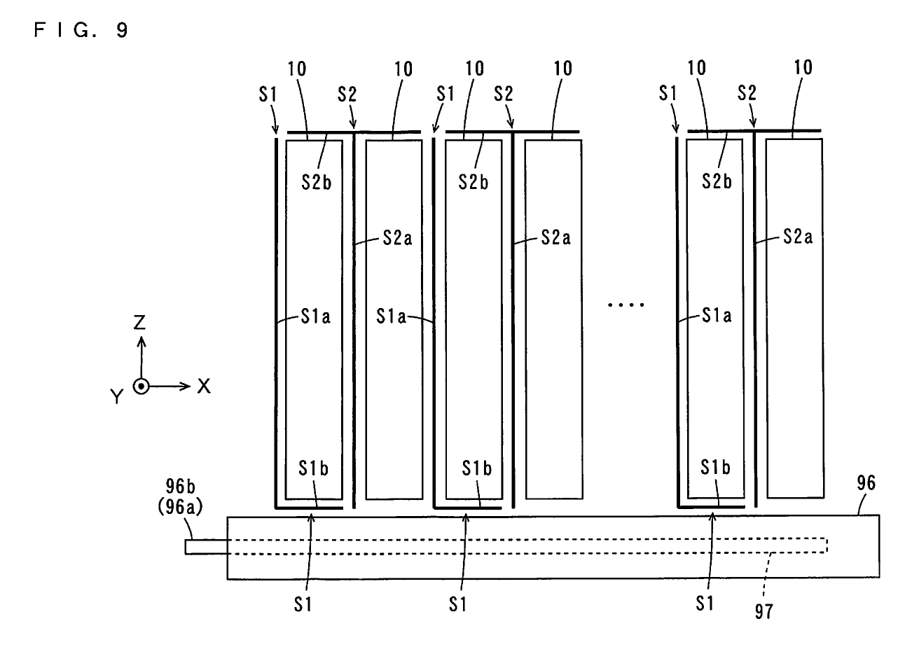

FIG. 9 is a schematic side view illustrating a fifth arrangement example of the separators S1 and S2. The example illustrated in FIG. 9 will be described by referring to differences from the example illustrated in FIG. 5. In the example illustrated in FIG. 9, the separator S1 corresponding to the (2k−1)-th battery cell 10 in each of the battery cell pairs is not provided.

In this example, heat generated by the 2k-th battery cell 10 in each of the battery cell pairs is absorbed in the cooling plate 96 via the corresponding separator S1, like in the example illustrated in FIG. 5. On the other hand, one side surface of the (2k−1)-th battery cell 10 in each of the battery cell pairs contacts the side surface portion S1a in the separator S1 corresponding to the adjacent (2k−2)-th battery cell 10. A bottom surface of the (2k−1)-th battery cell 10 contacts the cooling plate 96. Thus, heat generated by the (2k−1)-th battery cell 10 is absorbed in the cooling plate 96 via the separator S1 corresponding to the (2k−2)-th battery cell 10 while being directly absorbed in the cooling plate 96 from the bottom surface. Thus, each of the battery cells 10 can be efficiently cooled while the number of separators S1 is reduced. As a result, the manufacturing cost of the battery module 100 can be reduced.

(1-4-5) Sixth Arrangement Example

While in the examples illustrated in FIGS. 5 to 9, the bottom surface portion S1b in each of all the separators S1 is arranged between the bottom surface of the corresponding battery cell 10 and the upper surface of the cooling plate 96, the present invention is not limited to this. With respect to at least some of the separators S1, the bottom surface portion S1b may be arranged at a position on the cooling plate 96 that is not between the bottom surface of the battery cell 10 and the upper surface of the cooling plate 96, and the side surface portion S1a may be arranged to contact the one side surface or the other side surface of the battery cell 10.

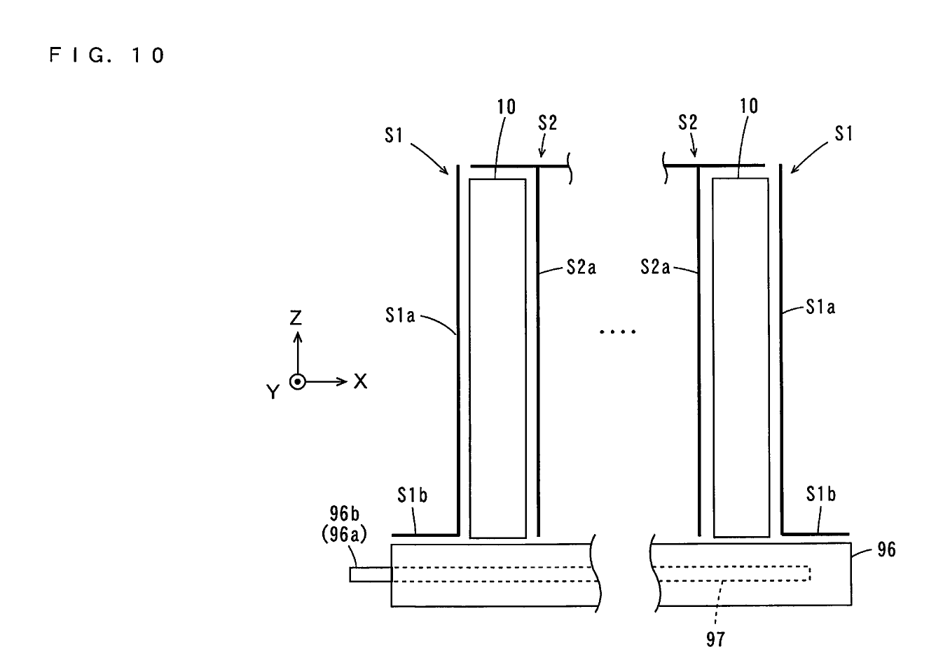

FIG. 10 is a schematic side view illustrating a sixth arrangement example of the separators S1 and S2. The example illustrated in FIG. 10 will be described by referring to differences from the example illustrated in FIG. 5. In the example illustrated in FIG. 10, with respect to the separators S1 corresponding to each of the first and M-th battery cells 10, the bottom surface portion S1b is directed toward the opposite side to the battery cell 10, and is arranged at a position on the cooling plate 96 that is not between the bottom surface of the battery cell 10 and the upper surface of the cooling plate 96. The bottom surface portions S1b in the separators S1 are respectively arranged between the one and other end plates 92 (FIG. 1) and the upper surface of the cooling plate 96, for example.

In this case, the side surface portions S1a in the separators S1 respectively contact the one side surface of the first battery cell 10 and the other side surface of the M-th battery cell 10.

Therefore, heat generated by the battery cell 10 is easily transmitted to the separator S1. Since the bottom surface portion S1b in the separator S1 overlaps the upper surface of the cooling plate 96, heat is easily transmitted to the cooling plate 96 from the separator S1. As a result, each of the battery cells 10 can be efficiently cooled.

(1-5) Another Example of Separator

(1-5-1)

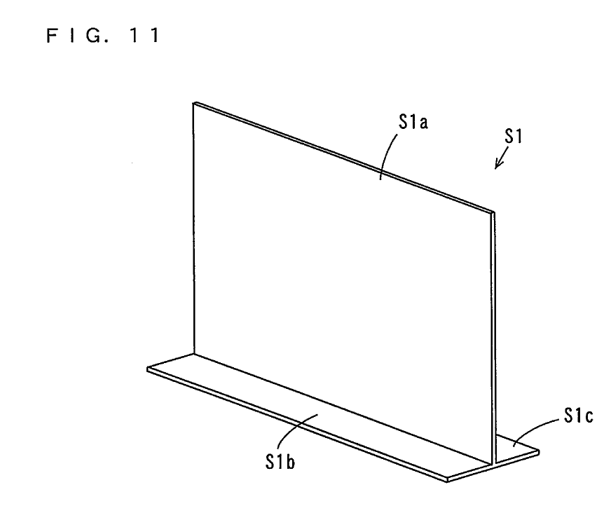

FIG. 11 is an external perspective view illustrating another example of the separator S1. The separator S1 illustrated in FIG. 11 has a similar configuration to that of the separator S1 illustrated in FIG. 3 except that it is provided with a bottom surface portion S1c projecting by a predetermined width perpendicularly to the other surface of the side surface portion S1a from the lower end of the side surface portion S1a. The side surface portion S1b is an example of a first portion of a first thermal conduction plate, and the bottom surface portion S1c is an example of a second portion of the first thermal conduction plate.

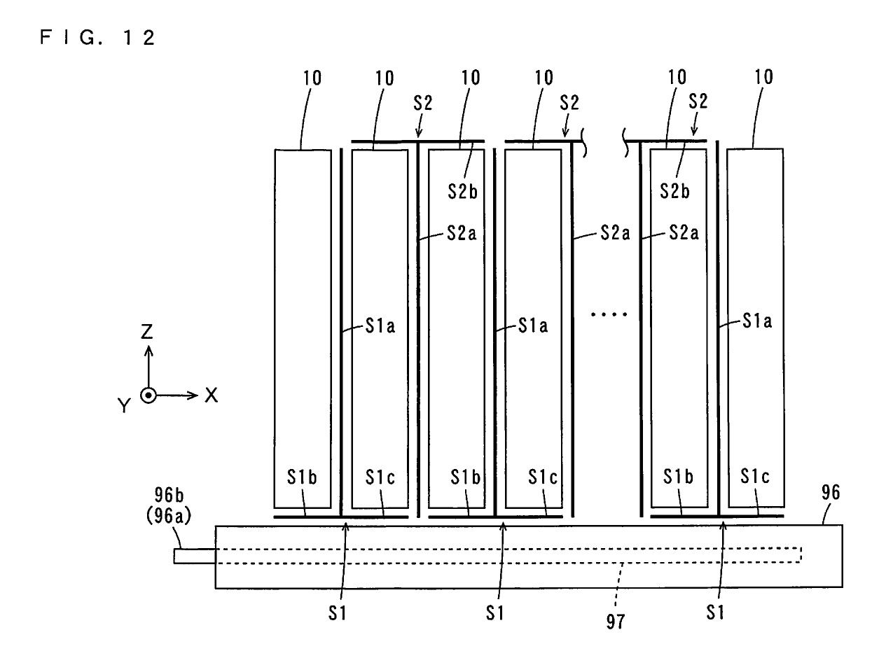

FIG. 12 is a schematic side view illustrating an arrangement example of the separator S1 illustrated in FIG. 11. In the example illustrated in FIG. 12, the two battery cells 10, i.e., the (2k−1)-th and 2k-th battery cells 10 adjacent to each other also constitute a battery cell pair. A plurality of separators S1 are arranged to respectively correspond to a plurality of battery cell pairs. The (2k−1)-th battery cell 10 in each of the battery cell pairs is arranged on the bottom surface portion S1c in the corresponding separator S1, and the 2k-th battery cell 10 in the battery cell pair is arranged on the bottom surface portion S1b in the corresponding separator S1.

In this case, the bottom surface portion S1c is arranged between the upper surface of the cooling plate 96 and a bottom surface of the (2k−1)-th battery cell 10, and the bottom surface portion S1b is arranged between the upper surface of the cooling plate 96 and a bottom surface of the 2k-th battery cell 10. Thus, the bottom surface portion S1c contacts the bottom surface of the (2k−1)-th battery cell 10 while contacting the upper surface of the cooling plate 96, and the bottom surface portion S1b contacts the bottom surface of the 2k-th battery cell 10 while contacting the upper surface of the cooling plate 96. An interposition member such as a thermally conductive rubber or a thermally conductive adhesive for making the battery cell 10 to adhere on the cooling plate 96 may be arranged at least between the bottom surface portions S1b and S1c in the separator S1 and the bottom surfaces of the battery cells 10 and between the bottom surface portions S1b and S1c in the separator S1 and the upper surface of the cooling plate 96.

The other side surface of the (2k−1)-th battery cell 10 in each of the battery cell pairs contacts the side surface portion S1a in the corresponding separator S1, and the one side surface of the 2k-th battery cell 10 in the battery cell pair contacts the side surface portion S1a in the corresponding separator S1.

The side surface portion S2a in the separator S2 is arranged between the other side surface of the 2k-th battery cell 10 in each of the battery cell pairs and one side surface of the adjacent (2k+1)-th battery cell 10. The other side surface of the 2k-th battery cell 10 in each of the battery cell pairs and the one side surface of the adjacent (2k+1)-th battery cell 10 contact the side surface portion S2a in the separator S2.

In this example, a contact area between each of the battery cells 10 and the corresponding separator S1 is also increased. Therefore, heat generated by each of the battery cells 10 is easily transmitted to the separator S1. As a result, each of the battery cells 10 can be efficiently cooled. The separator S2 suppresses thermal conduction between the adjacent battery cell pairs so that chained thermal conduction between the plurality of battery cells 10 is prevented.

Further, the one separator S1 is used to correspond to the two battery cells 10. Therefore, the number of separators S1 can be made smaller than those in the examples illustrated in FIGS. 5 to 8. Thus, the battery module 100 is easily assembled.

In this example, with respect to at least some of the separators S1, one of the bottom surface portions S1b and S1c may also be arranged at a position on the cooling plate 96 that is not between the bottom surface of the corresponding battery cell 10 and the upper surface of the cooling plate 96.

While the separator S1 illustrated in FIG. 3 is used in the examples illustrated in FIGS. 5 to 10, and the separator S1 illustrated in FIG. 11 is used in the example illustrated in FIG. 12, both the separator S1 illustrated in FIG. 3 and the separator S1 illustrated in FIG. 11 may be used.

(1-5-2)

While in the above-mentioned examples, the separator S2 is used to suppress thermal conduction between the adjacent battery cells 10, the present invention is not limited to this. For example, the separator S2 may be used to cool the battery cell 10. In this case, the separator S2 is formed of a similar material having high thermal conductivity to that for the separator S1. The side surface portion S2a in the separator S2 contacts one side surface or the other side surface of the battery cell 10 so that heat is conducted from the battery cell 10 to the side surface portion S2a in the separator S2. The projection portion S2b in the separator S2 contacts cooling gas so that heat transmitted to the side surface portion S2a from the battery cell 10 is absorbed in the gas from the projection portion S2b. Thus, the battery cell 10, which contacts the side surface portion S2a in the separator S2, is cooled.

Thus, the separator S2 is used to cool the battery cell 10 so that a cooling effect of the battery cell 10 by the separator S1 as well as a cooling effect of the battery cell 10 by the separator S2 is obtained. Thus, each of the battery cells 10 can be more efficiently cooled.

The separator S2 may be merely used to electrically insulate the adjacent battery cells 10. In this case, the separator S2 having an electrically insulating property is used.

(1-5-3)

While the bottom surface portion S1b is provided to integrally extend from one end of a lower end of the side surface portion S1a to the other end thereof in the separator S1 illustrated in FIG. 3, and the bottom surface portions S1b and S1c are provided to integrally extend from one end of a lower end of the side surface portion S1a to the other end thereof in the separator S1 illustrated in FIG. 11, the shapes of the bottom surface portions S1b and S1c are not limited to these. If thermal conductivity between the bottom surface portions S1b and S1c and the cooling plate 96 can be ensured, each of the bottom surface portions S1b and S1c may be separated into a plurality of portions, similarly to the projection portion S2b in the separator S2 illustrated in FIG. 4.

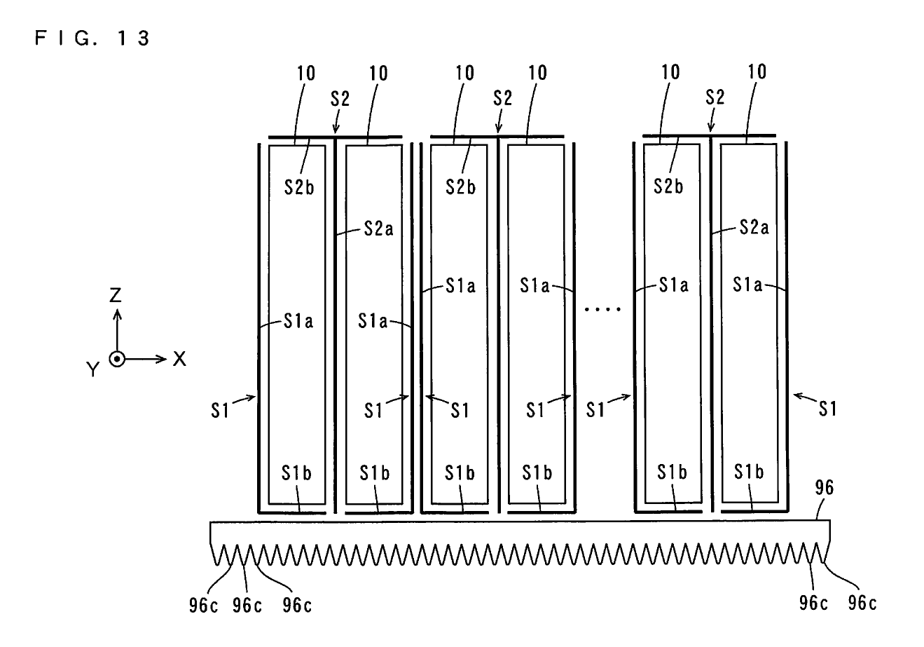

While the pair of projection portions S2b is provided at an upper end of the side surface portion S2a in the separator S2 illustrated in FIG. 4, the present invention is not limited to this. The projection portions S2b may be provided to integrally extend from one end of an upper end of the side surface portion S2a to the other end thereof. More specifically, the separator S2 may have a shape in which the separator S1 illustrated in FIG. 11 is reversed in the vertical direction (Z-direction). Similarly, the separator S2 may have a shape in which the separator S1 illustrated in FIG. 3 is reversed in the vertical direction (Z-direction). When the separator S2 is used to cool the battery cell 10, the projection portion S2b is provided to integrally extend from the one end of the upper end of the side surface potion S2a to the other end thereof so that heat is more efficiently released from the projection portion S2b, resulting in an increased cooling effect of the battery cell 10. A plurality of projections serving as a cooling fin may be provided on an upper surface of the projection portion S2b in the separator S2 (see projections 96c illustrated in FIG. 13, described below). The projection portion S2b may be provided with a hole, a groove, or a notch so that the electrodes 10a and 10b and the gas vent valve 10v of the battery cell 10, and the bus bar 40 are not covered with the projection portion S2b. On the other hand, when the separator S2 is used for a purpose other than cooling of the battery cell 10, the projection portion S2b need not be provided.

(1-6) Miniaturization of Battery Module

Considered as a configuration of the battery module 100 is one in which between adjacent ones of all the battery cells 10, two thermal conduction plates (the side surface portions S1a in the separators S1 in this example) are arranged and a thermal insulation plate (the side surface portion S2a in the separator S2 in this example) is sandwiched between the two thermal conduction plates. However, the size of the battery module 100 is increased in such a configuration.

On the other hand, in the above-mentioned example, not more than one separator S1 and not more than one separator S2 are used to correspond to one battery cell 10. Therefore, the side surface portions S1a in the two separators S1 and the side surface portion S2a in the one separator S2 are not arranged between adjacent ones of all the battery cells 10. Therefore, the size of the battery module 100 is inhibited from being increased.

Particularly, in the examples illustrated in FIGS. 9 and 12, one separator S1 is used to correspond to two battery cells 10. In the examples illustrated in FIGS. 5, 6, 9, 10 and 12, one separator S2 is used to correspond to two battery cells 10. Thus, the size of the battery module 100 is further inhibited from being increased.

(1-7) Another Example of Cooling Plate

FIG. 13 is a schematic side view illustrating another example of the cooling plate 96. The cooling plate 96 illustrated in FIG. 13 will be described by referring to differences from the cooling plate 96 illustrated in FIGS. 5 to 10 and FIG. 12. While the separators S1 and S2 are arranged in FIG. 13, like in the example illustrated in FIG. 5, the separators S1 and S2 may have the other arrangements and configurations, described above.

The cooling plate 96 illustrated in FIG. 13 does not include a refrigerant inlet 96a, a refrigerant outlet 96b, and a refrigerant path 97, and has a plurality of projections 96c provided on its lower surface. In this case, the plurality of projections 96c function as a cooling fin, and heat transmitted from each of the battery cells 10 to the cooling plate 96 is released from the plurality of projections 96c. Thus, each of the battery cells 10 is cooled.

Cooling gas is preferably supplied to contact the plurality of projections 96c. In this case, heat is released more efficiently from the plurality of projections 96c. Thus, each of the battery cells 10 can be more efficiently cooled.

(1-8) Bus Bar

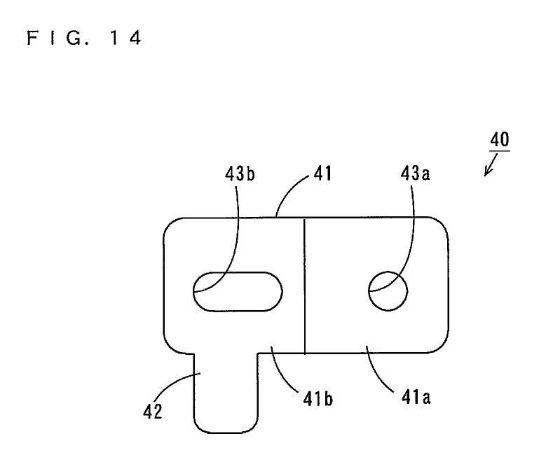

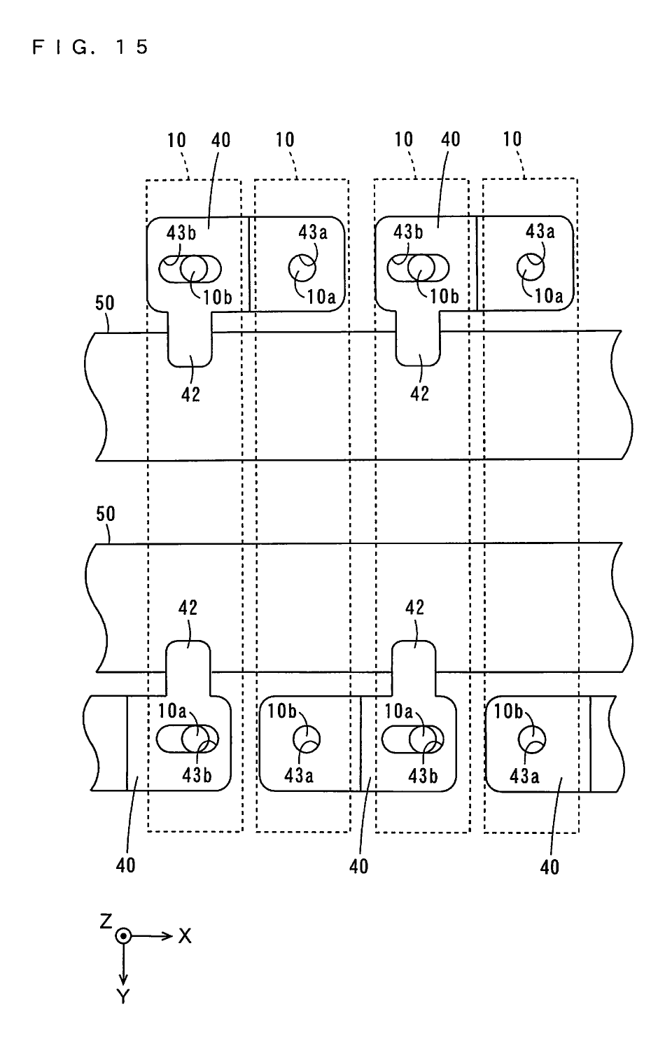

FIG. 14 is a plan view illustrating an example of a bus bar 40 used in the present embodiment. FIG. 15 is a schematic plan view illustrating bus bars 40 that remain attached, respectively, to the plurality of battery cells 10.

As illustrated in FIG. 14, the bus bar 40 includes a rectangular plate-shaped base portion 41 and an attachment portion 42. The base portion 41 includes regions 41a and 41b. The region 41a is formed of aluminum, for example, and the region 41b is formed of copper, for example. In this example, the base portion 41 is formed of two types of materials to prevent electric erosion between the bus bar 40 and the electrodes 10a and 10b of the battery cell 10. If electric erosion between the bus bar 40 and the electrodes 10a and 10b of the battery cell 10 can be prevented, the base portion 41 may be formed of a single material. The attachment portion 42 projects from the long side of the region 41b in the base portion 41. In the base portion 41, a circular electrode connection hole 43a and an oval electrode connection hole 43b extending in the X-direction (see FIG. 15) are formed in the base portion 41.

As illustrated in FIG. 15, the attachment portion 42 in each of the bus bars 40 is attached to an FPC board 50 by soldering, for example. The plus electrode 10a and the minus electrode 10b, which are to be connected to each other, of the adjacent battery cells 10 are respectively fitted in the electrode connection holes 43a and 43b in the bus bar 40.

A spacing between the adjacent battery cells 10 differs depending on the number of separators S1 and S2 to be arranged and their types. For example, in the example illustrated in FIG. 5, a spacing between the adjacent battery cells 10 differs in an area where the side surface portions S1a in the two separators S1 are arranged and an area where the side surface portion S2a in the one separator S2 is arranged. If the spacing between the adjacent battery cells 10 thus varies, the distance between the plus electrode 10a and the minus electrode 10b (hereinafter referred to as a between-electrode distance), which are to be connected to each other, varies.

The bus bar 40 illustrated in FIG. 14 is used so that one of the plus electrode 10a and the minus electrode 10b, which are to be connected to each other, can be arranged at any position within the electrode connection hole 43b formed in an oval shape. If the between-electrode distance varies, the common bus bar 40 can be used.

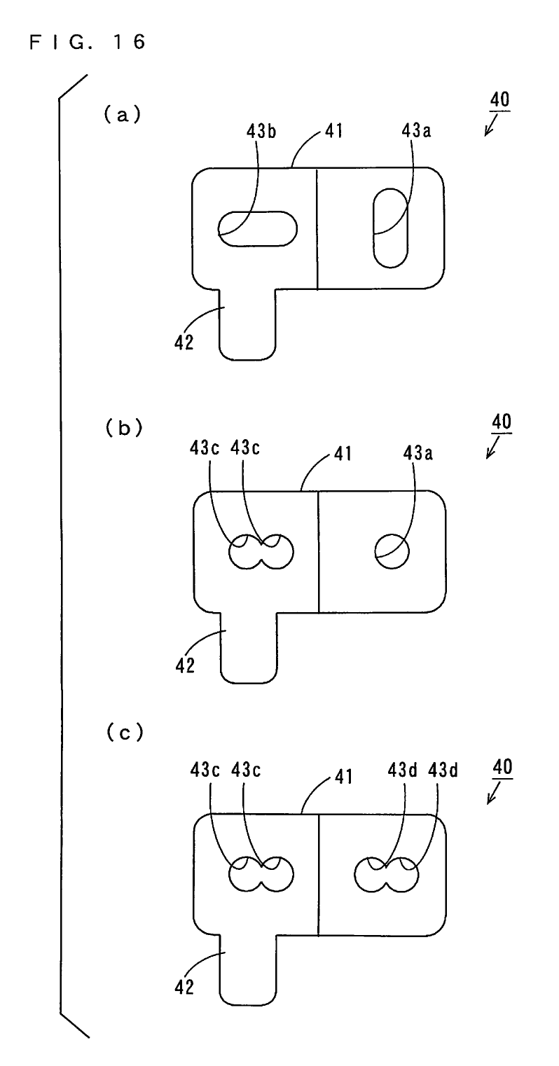

FIGS. 16 (a), 16 (b) and 16 (c) are schematic plan views each illustrating another example of the bus bar 40. The bus bar 40 illustrated in FIG. 16 (a) has a similar configuration to that of the bus bar 40 illustrated in FIG. 14 except that the electrode connection hole 43a is formed in an oval shape extending in the Y-direction (see FIG. 15). The respective positions of the plus electrode 10a and the minus electrode 10b, which are to be connected to each other, of the adjacent battery cells 10 may be shifted in the Y-direction depending on a manufacturing error or an assembling error. If the bus bar 40 illustrated in FIG. 16 (a) is used, the direction of the bus bar 40 can be adjusted with the bus bar 40 fitted in each of the plus electrode 10a and the minus electrode 10b of the adjacent battery cells 10. Even if the plus electrode 10a and the minus electrode 10b, which are to be connected to each other, are shifted in the Y-direction, therefore, the direction of the bus bar 40 can be kept constant. Therefore, the direction of the plurality of bus bars 40 is prevented from varying. As a result, the FPC board 50 is prevented from being distorted.

The bus bar 40 illustrated in FIG. 16 (b) has a similar configuration to that of the bus bar 40b illustrated in FIG. 14 except that a pair of circular electrode connection holes 43c is integrally formed instead of the oval electrode connection hole 43b.

In this case, one of the plus electrode 10a and the minus electrode 10b, which are to be connected to each other, is fitted in the electrode connection hole 43a, and the other electrode is selectively fitted in either one of the pair of electrode connection holes 43c. Even if there are two types of between-electrode distances, therefore, the common bus bar 40 can be used.

The bus bar 40 illustrated in FIG. 16 (c) has a similar configuration to that of the bus bar 40 illustrated in FIG. 16 (b) except that two circular electrode connection holes 43d are integrally formed instead of the circular electrode connection hole 43a.

In this case, one of the plus electrode 10a and the minus electrode 10b, which are to be connected to each other, is selectively fitted in either one of the pair of electrode connection holes 43d, and the other electrode is selectively fitted in either one of the pair of electrode connection holes 43c. Even if there are two to four types of between-electrode distances, therefore, the common bus bar 40 can be used.

(1-9) Another Arrangement Example of Plus Electrode and Minus Electrode

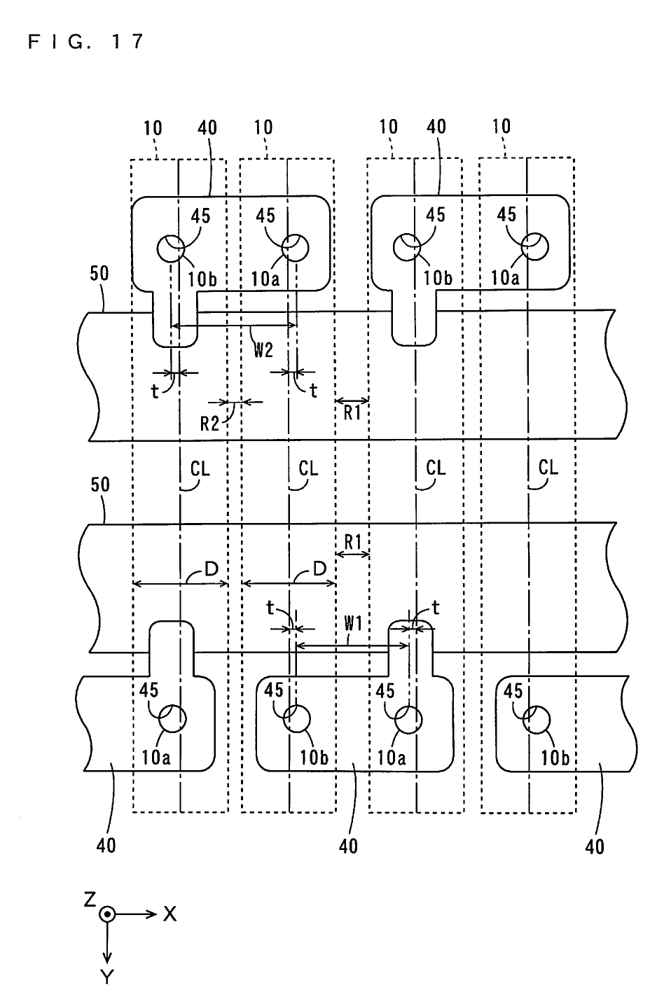

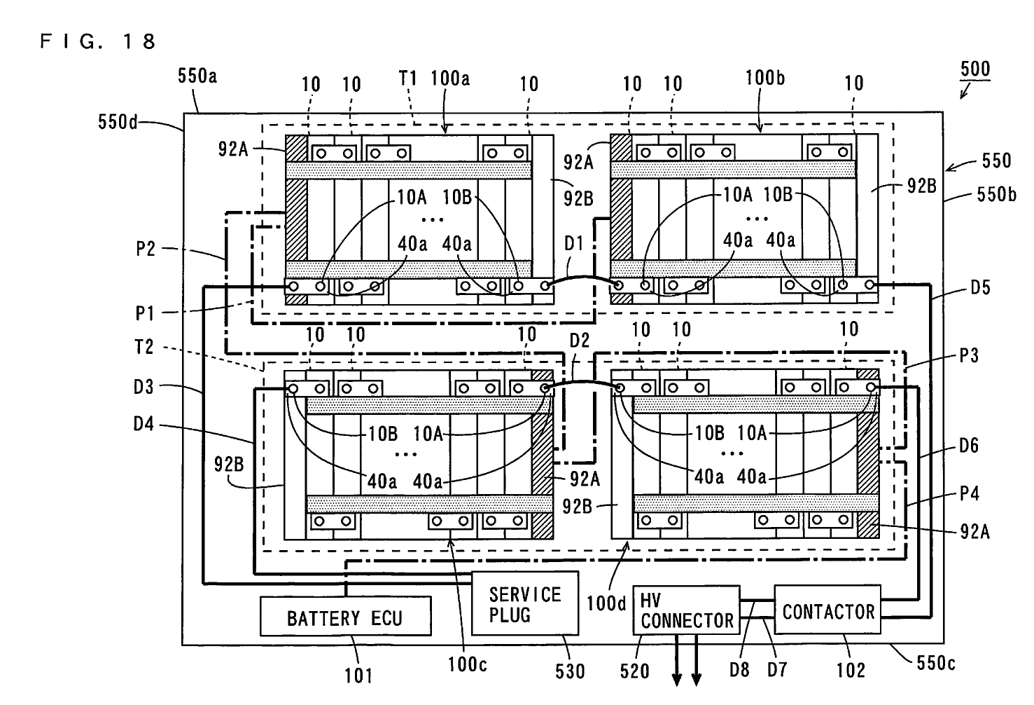

FIG. 17 is a schematic plan view illustrating another arrangement example of the plus electrode 10a and the minus electrode 10b in each of the battery cells 10. FIG. 17 illustrates lines (hereinafter referred to as center lines) CL passing through the centers of one surface and the other surface, which are perpendicular to the X-direction, of each of the battery cells 10. In the example illustrated in FIG. 17, the plurality of battery cells 10 are arranged so that spacings between the adjacent battery cells 10 are alternately R1 and R2.

In the example illustrated in FIG. 17, respective axial centers of the plus electrode 10a and the minus electrode 10b of each of the battery cells 10 are shifted by a distance t from the center line CL to approach one side surface and the other side surface of the battery cell 10.

Letting D be the thickness of each of the battery cells 10, W1 be a between-electrode distance in an area where a spacing between the adjacent battery cells is R1, and W2 be a between-electrode distance in an area where a spacing between the adjacent battery cells is R2, the following equations (1) and (2) hold:

2 (D/2−t)+R1=W1 (1)

2 (D/2+t)+R2=W2 (2)

The distance t is set so that the between-electrode distance W1 and the between-electrode distance W2 are equal to each other. Therefore, the distance t is set to satisfy the following equation:

2 (D/2−t)+R2=2 (D/2+1)+R1

The distance t is expressed by the following equation from the foregoing equation:

t=(R2−R1)/4

In this case, the between-electrode distances W1 and W2 are equal to each other. Therefore, a bus bar 40 having a simple shape in which a pair of circular electrode connection holes 45 is formed at a predetermined spacing can be used in both the area where the spacing between the adjacent battery cells is R1 and the area where the spacing between the adjacent battery cells is R2.

### (2) Second Embodiment

A battery system according to a second embodiment of the present invention will be described. The battery system according to the present embodiment includes the battery module 100 according to the above-mentioned first embodiment.

(2-1) Overall Configuration

FIG. 18 is a schematic plan view illustrating a configuration of a battery system according to the second embodiment. As illustrated in FIG. 18, a battery system 500 includes battery modules 100a, 100b, 100c and 100d, a battery ECU 101, a contactor 102, a high voltage (HV) connector 520, and a service plug 530. The battery modules 100a to 100d have similar configurations to that of the battery module 100 according to the first embodiment. In this case, the separator S1 illustrated in FIG. 3 may be used. Alternatively, the separator S1 illustrated in FIG. 11 may be used. The separators S1 and S2 may be arranged in any one of the arrangement examples illustrated in FIGS. 5 to 10 and FIG. 12. The number of battery modules 100a to 100d and their arrangement are not limited to those in this example, and can be changed, as needed. In the following description, in each of the battery modules 100a to 100d, a highest-potential plus electrode 10a is referred to as a high-potential terminal 10A, and a lowest-potential minus electrode 10b is referred to as a low-potential terminal 10B. One, to which a printed circuit board 21 is attached, of a pair of end plates 92 provided in each of the battery modules 100a to 100d is referred to as an end plate 92A, and the end plate to which the printed circuit board 21 is not attached is referred to as an end plate 92B.

The battery modules 100a to 100d, the battery ECU 101, the contactor 102, the HV connector 520, and the service plug 530 are housed in a box-shaped casing 550. The casing 550 has side surface portions 550a, 550b, 550c and 550d. The side surface portions 550a and 550c are parallel to each other. The side surface portions 550b and 550d are parallel to each other and are perpendicular to the side surface portions 550a and 550c.

Within the casing 550, the battery modules 100a and 100b are arranged to line up in one row along the side surface portion 550a. In this case, the battery modules 100a and 100b are arranged so that the end plate 92B in the battery module 100a and the end plate 92A in the battery module 100b face each other at a spacing. The end plate 92A in the battery module 100a is directed toward the side surface portion 550d, and the end plate 92B in the battery module 100b is directed toward the side surface portion 550b.

The battery modules 100c and 100d are arranged to line up in one row in parallel with the battery modules 100a and 100b. In this case, the battery modules 100c and 100d are arranged so that the end plate 92A in the battery module 100c and the end plate 92B in the battery module 100d face each other at a spacing. The end plate 92B in the battery module 100c is directed toward the side surface portion 550d, and the end plate 92A in the battery module 100c is directed toward the side surface portion 550b. The battery module ECU 101, the service plug 530, the HV connector 520, and the contactor 102 are arranged to line up in this order from the side surface portion 550d to the side surface portion 550b in a region between the battery modules 100c and 100d and the side surface portion 550c.

One end of an electric power line D1 is connected to a bus bar 40 attached to the low potential terminal 10B of the battery module 100a. The other end of the electric power line D1 is connected to a bus bar 40 attached to the high potential terminal 10A of the battery module 100b. Thus, the low potential terminal 10B of the battery module 100a and the high potential terminal 10A of the battery module 100b are electrically connected to each other. Examples of the electric power lines D1 and D2 and electric power lines D3 to D7, described below, include a harness or a lead wire. The electric power lines D1 and D2 may be replaced with long-sized bus bars.

One end of the electric power line D2 is connected to a bus bar 40a attached to the high potential terminal 10A of the battery module 100c. The other end of the electric power line D2 is connected to a bus bar 40a attached to the low potential terminal 10B of the battery module 100d. Thus, the high potential terminal 10A of the battery module 100c and the low potential terminal 10B of the battery module 100d are electrically connected to each other.

One end of the electric power line D3 is connected to a bus bar 40a attached to the high potential terminal 10A of the battery module 100a. One end of the electric power line D4 is connected to a bus bar 40a attached to the low potential terminal 10B of the battery module 100c. The other ends of the electric power lines D3 and D4 are connected to the service plug 530.

With the service plug 530 turned on, the battery modules 100a, 100b, 100c and 100d are connected in series. In this case, a potential at the high potential terminal 10A of the battery module 100d is the highest, and a potential at the low potential terminal 10B of the battery module 100b is the lowest.

The service plug 530 is turned off by a worker during maintenance of the battery system 500, for example. If the service plug 530 is turned off, a series circuit of the battery modules 100a and 100b and a series circuit of the battery modules 100c and 100d are electrically separated from each other. In this case, a current path between the plurality of battery modules 100a to 100d is blocked. Thus, safety during maintenance is ensured.

One end of the electric power line D5 is connected to a bus bar 40a attached to the low potential terminal 10B of the battery module 100b. One end of the electric power line D6 is connected to a bus bar 40a attached to the high potential terminal 10A of the battery module 100d. The other ends of the electric power lines D5 and D6 are connected to the contactor 102. The contactor 102 is connected to the HV connector 520 via the electric power lines D7 and D8. The HV connector 520 is connected to an external load.

With the contactor 102 turned on, the battery module 100b is connected to the HV connector 520 via the electric power lines D5 and D7 while the battery module 100d is connected to the HV connector 520 via the electric power lines D6 and D8. Thus, electric power is supplied to the load from the battery modules 100a to 100d. With the contactor 102 turned on, the battery modules 100a to 100d are charged. When the contactor 102 is turned off, connection between the battery module 100b and the HV connector 520 and connection between the battery module 100d and the HV connector 520 are cut off.

When the battery system 500 is maintained, the contactor 102, together with the service plug 530, is turned off by the worker. In this case, a current path between the plurality of battery modules 100a to 100d is reliably blocked. Thus, safety during maintenance is sufficiently ensured. If respective voltages of the battery modules 100a to 100d are equal to one another, a total voltage of the series circuit of the battery modules 100a and 100b and a total voltage of the series circuit of the battery modules 100c and 100d are equal to each other. Therefore, a high voltage is prevented from being generated within the battery system 500 during maintenance.

The printed circuit board 21 (see FIG. 1) in the battery module 100a and the printed circuit board 21 in the battery module 100b are connected to each other via a communication line P1. The printed circuit board 21 in the battery module 100a and the printed circuit board 21 in the battery module 100c are connected to each other via a communication line P2. The printed circuit board 21 in the battery module 100c and the printed circuit board 21 in the battery module 100d are connected to each other via a communication line P3. The printed circuit board 21 in the battery module 100d is connected to the battery ECU 101 via a communication line P4. The communication lines P1 to P4 constitute a bus. Examples of the communication lines P1 to P4 include a harness.

Communication is performed between the communication paths 24 in the battery modules 100a to 100d and the battery ECU 101 via the communication lines P1 to P4. Each of the communication circuits 24 feeds information (a terminal voltage, a current, and a temperature) relating to each of the battery cells 10 to the other communication path 24 or the battery ECU 101. The information relating to the battery cell 10 is referred to as cell information.

The battery ECU 101 calculates a charged capacity of each of the battery cells 10 in each of the battery modules 100a to 100d based on the cell information fed from the communication circuit 24 in the battery module, for example, and performs charge/discharge control of the battery module based on the charged capacity. The battery ECU 101 detects an abnormality in each of the battery modules 100a to 100d based on the cell information fed from the communication circuit 24 in the battery modules 100a to 100d. Examples of abnormalities in the battery modules 100a to 100d include overdischarge, overcharge, and an abnormality in temperature of the battery cell 10.

While the battery ECU 101 calculates the charged capacity of each of the battery cells 10 and detects overdischarge, overcharge, and an abnormality in temperature of the battery cell 10 in the present embodiment, the present invention is not limited to this. The communication circuit 24 in each of the battery modules 100a to 100d may calculate the charged capacity of each of the battery cells 10 and detect overdischarge, overcharge, or an abnormality in temperature of the battery cell 10, and may feed their results to the battery ECU 101.

(2-2) Connection of Cooling Plate

FIG. 19 is a schematic view for illustrating a circulation system of a coolant in the battery system 500.

As illustrated in FIG. 19, a casing 550 is provided with piping connectors CC1 and CC2. A supply piping C1 and a recovery piping C2 are provided to extend into the casing 550 from the piping connectors CC1 and CC2. The supply piping C1 is connected to a refrigerant inlet 96a in the battery module 100a via a piping C11, is connected to a refrigerant inlet 96a in the battery module 100b via a piping C12, is connected to a refrigerant inlet 96a in a battery module 100c via a piping C13, and is connected to a refrigerant inlet 96a in a battery module 100d via a piping C14. The recovery piping C2 is connected to a refrigerant outlet 96b in the battery module 100a via a piping C21, is connected to a refrigerant outlet 96b in the battery module 100b via a piping C22, and is connected to a refrigerant outlet 96b in the battery module 100c via a piping C23, and is connected to a refrigerant outlet 96b in the battery module 100d via a piping C24.

A circulation pump 98 and a heat exchanger 99 are provided outside the casing 550. An example of the heat exchanger 99 is a radiator. The heat exchanger 99 is connected to the piping connectors CC1 and CC2 via pipings C31 and C32, respectively. The circulation pump 98 is inserted into the piping connector C31.

The circulation pump 98 feeds a refrigerant, which has been cooled by the heat exchanger 99, to a cooling plate 96 in each of the battery modules 100a to 100d via the piping C31, the supply piping C1, and the pipings C11 to C14. The circulation pump 98 feeds a refrigerant, which has absorbed heat in each of the battery modules 100a to 100d, to the heat exchanger 99 from the cooling plate 96 in the battery module via the pipings C21 to C24, the recovery piping C2, and the piping C32. Thus, the refrigerant is circulated between the cooling plate 96 in each of the battery modules 100a to 100d and the heat exchanger 99.

(2-3) Effects

The battery system 500 according to the present embodiment is provided with the battery module 100 according to the above-mentioned first embodiment. Therefore, each of the battery cells 10 can be efficiently cooled. Therefore, the reliability of the battery system 500 is improved.

### (3) Third Embodiment

An electric vehicle and a movable body according to a third embodiment of the present invention will be described. The electric vehicle includes a hybrid electric vehicle (HEV), a plug-in hybrid electric vehicle (PHEV), and a battery electric vehicle (EV). The electric vehicle and the movable body according to the present embodiment include the battery system 500 according to the second embodiment. An electric automobile will be described below as an example of the electric vehicle.

(3-1) Configuration and Operation

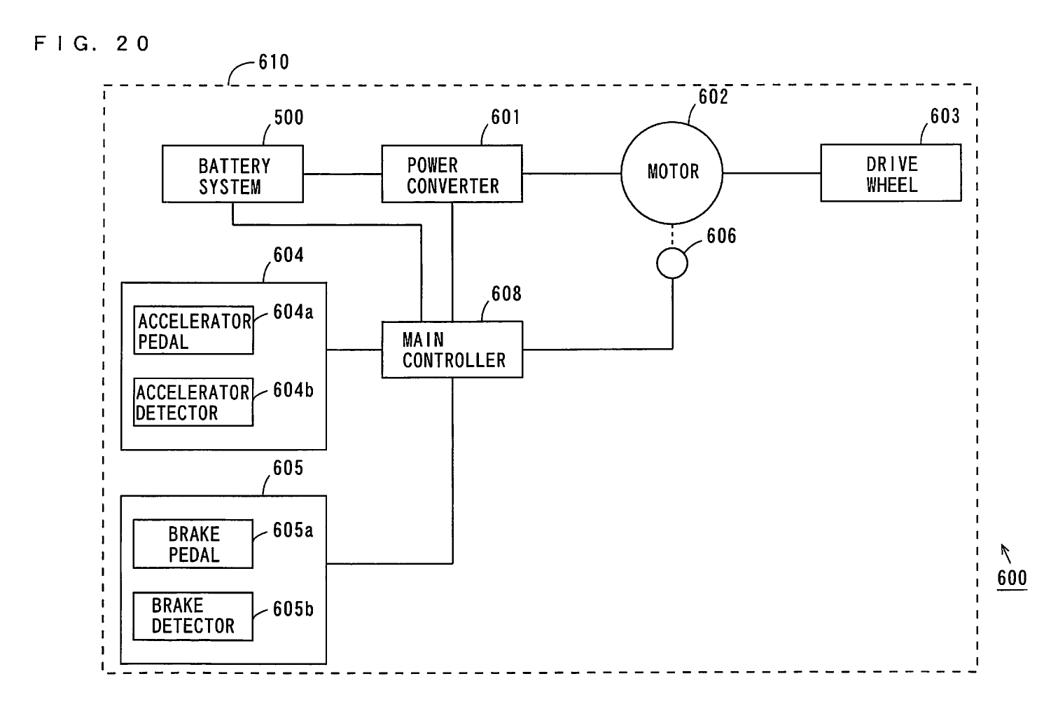

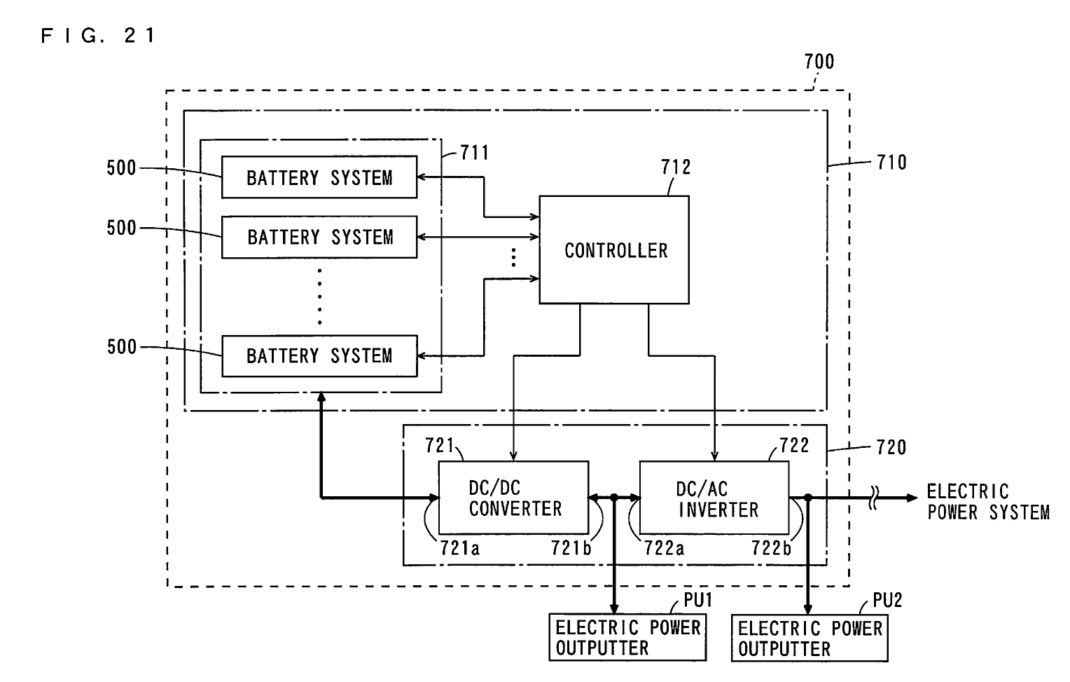

FIG. 20 is a block diagram illustrating a configuration of the electric automobile according to the third embodiment. As illustrated in FIG. 20, an electric automobile 600 according to the present embodiment includes a vehicle body 610. The vehicle body 610 includes the above-mentioned battery system 500, a power converter 601, a motor 602, a drive wheel 603, an accelerator device 604, a brake device 605, a rotational speed sensor 606, and a main controller 608. If the motor 602 is an alternating current (AC) motor, the power converter 601 includes an inverter circuit.

The battery system 500 is connected to the motor 602 via the power converter 601 while being connected to the main controller 608. The battery system ECU 101 (see FIG. 18) in the battery system 500 calculates a charged capacity of each of the battery cells 10 based on a terminal voltage of the battery cell 10.

The charged capacity of each of the battery cells 10 is given to the main controller 608 from the battery ECU 101. The accelerator device 604, the brake device 605, and the rotational speed sensor 606 are connected to the main controller 608. The main controller 608 includes a central processing unit (CPU) and a memory, or a microcomputer, for example.

The accelerator device 604 includes an accelerator pedal 604a and an accelerator detector 604b that detects an operation amount (depression amount) of the accelerator pedal 604a, which are included in the electric automobile 600. When a user operates the accelerator pedal 604a, the accelerator detector 604b detects the operation amount of the accelerator pedal 604a based on a state where the user does not operate the accelerator detector 604b. The detected operation amount of the accelerator pedal 604a is given to the main controller 608.

The brake device 605 includes a brake pedal 605a and a brake detector 605b that detects an operation amount (depression amount) of the brake pedal 605a by the user, which are included in the electric automobile 600. When the user operates the brake pedal 605a with the ignition key turned on, the brake detector 605b detects the operation amount. The detected operation amount of the brake pedal 605a is given to the main controller 608. The rotational speed sensor 606 detects a rotational speed of the motor 602. The detected rotational speed is given to the main controller 608.

As described above, the charged capacity of each of the battery cells 10, the operation amount of the accelerator pedal 604a, the operation amount of the brake pedal 605a, and the rotational speed of the motor 602 are given to the main controller 608. The main controller 608 performs charge/discharge control of the plurality of battery cells 10 and electric power conversion control of the power converter 601 based on the information. When the electric automobile 600 is started and accelerated based on an accelerator operation, for example, electric power from the plurality of battery cells 10 is supplied from the battery system 500 to the power converter 601. Further, with the ignition key turned on, the main controller 608 calculates a torque (a command torque) to be transmitted to the drive wheel 603 based on the given operation amount of the accelerator pedal 604a, and feeds a control signal based on the command torque to the power converter 601.

The power converter 601, which has received the above-mentioned control signal, converts the electric power supplied from the battery system 500 into electric power required to drive the drive wheel 603 (driving electric power). Thus, the driving electric power obtained by the conversion in the power converter 601 is supplied to the motor 602, and a torque generated by the motor 602 based on the driving electric power is transmitted to the drive wheel 603.

On the other hand, when the electric automobile 600 is decelerated based on a braking operation, the motor 602 functions as a power generation device. In this case, the power converter 601 converts regenerated electric power generated by the motor 602 into electric power suited to charge the plurality of battery cells 10, and feeds the electric power to the plurality of battery cells 10. Thus, the plurality of battery cells 10 are charged.

(3-2) Effects

The electric automobile 600 according to the present embodiment uses the battery system 500 according to the second embodiment. Therefore, each of the battery cells 10 can be efficiently cooled. Therefore, the reliability of the electric automobile 600 is improved.

(3-3) Another Movable Body

The battery system 500 according to the third embodiment may be loaded in another movable body such as a ship, an airplane, an elector, or a waling robot.

The ship, which is loaded with the battery system 500, includes a hull instead of the vehicle body 610 illustrated in FIG. 20, includes a screw instead of the drive wheel 603, includes an accelerator inputter instead of the accelerator device 604, and includes a deceleration inputter instead of the brake device 605, for example. A user operates the acceleration inputter instead of the accelerator device 604 in accelerating the hull, and operates the deceleration inputter instead of the brake device 605 in decelerating the hull. In this case, the hull corresponds to a main body, the motor corresponds to a power source, and the screw corresponds to a driver. The ship need not include the deceleration inputter. In this case, the user operates the acceleration inputter, to stop accelerating the hull so that the hull is decelerated by the resistance of water. In such a configuration, the motor receives electric power from the battery system 500, to convert the electric power into power, and the screw is rotated with the power obtained by the conversion so that the hull moves.

Similarly, the airplane, which is loaded with the battery system 500, includes an airframe instead of the vehicle body 610 illustrated in FIG. 20, includes a propeller instead of the drive wheel 603, includes an acceleration inputter instead of the accelerator device 604, and includes a deceleration inputter instead of the brake device 605, for example. In this case, the airframe corresponds to a main body, the motor corresponds to a power source, and the propeller corresponds to a driver. The airplane need not include the deceleration inputter. In this case, the user operates the acceleration inputter to stop acceleration so that the airframe is decelerated by the resistance of air. In such a configuration, the motor receives electric power from the battery system 500, to convert the electric power into power, and the propeller rotates with the power obtained by the conversion so that the airframe moves.

The elevator, which is loaded with the battery system 500, includes a cage instead of the vehicle body 610 illustrated in FIG. 20, includes a hoist rope, which is attached to the cage, instead of the drive wheel 603, includes an acceleration inputter instead of the accelerator device 604, and includes a deceleration inputter instead of the brake device 605, for example. In this case, the cage corresponds to a main body, the motor corresponds to a power source, and the hoist rope corresponds to a driver. In such a configuration, the motor receives electric power from the battery system 500, to convert the electric power into power, and the hoist rope is wound up with the power obtained by the conversion so that the cage rises and falls.

The walking robot, which is loaded with the battery system 500, includes a body instead of the vehicle body 610 illustrated in FIG. 20, includes a foot instead of the drive wheel 603, includes an acceleration inputter instead of the accelerator device 604, and includes a deceleration inputter instead of the brake device 605, for example. In this case, the body corresponds to a main body, the motor corresponds to a power source, and the foot corresponds to a driver. In such a configuration, the motor receives electric power from the battery system 500, to convert the electric power into power, and the foot is driven with the power obtained by the conversion so that the body moves.

Thus, in the movable body, which is loaded with the battery system 500, the power source receives the electric power from the battery system 500, to convert the electric power into power, and the driver moves the main body with the power obtained by the conversion in the power source.

(3-4) Effects in Another Movable Body

In various movable bodies, the battery system 500 according to the second embodiment is used so that each of the battery cells 10 can be efficiently cooled. Therefore, the reliability of the movable body is improved.

### (4) Fourth Embodiment

A power supply device according to a fourth embodiment of the present invention will be described. The power supply device according to the present embodiment includes the battery system 500 according to the second embodiment.

(4-1) Configuration and Operation

FIG. 21 is a block diagram illustrating a configuration of a power supply device according to a fourth embodiment. As illustrated in FIG. 21, a power supply device 700 includes a power storage device 710 and a power conversion device 720. The power storage device 710 includes a battery system group 711 and a controller 712. The battery system group 711 includes a plurality of battery systems 500 according to the third embodiment. A plurality of battery cells 10 may be arranged in parallel or may be connected in series between the plurality of battery systems 500.

The controller 712 is an example of a system controller, and includes a CPU and a memory, or a microcomputer, for example. The controller 712 is connected to the battery ECU 101 (FIG. 18) included in each of the battery systems 500. The battery ECU 101 in each of the battery systems 500 calculates a charged capacity of each of the battery cells 10 based on a terminal voltage of the battery cell 10, and feeds the calculated charged capacity to the controller 712. The controller 712 controls the power conversion device 720 based on the charged capacity of each of the battery cells 10, which has been fed from each of the battery ECUs 101, to perform control relating to discharge or charge of the plurality of battery cells 10 included in each of the battery systems 500.

The power conversion device 720 includes a direct current/direct current (DC/DC) converter 721 and a direct current/alternating current (DC/AC) inverter 722. The DC/DC converter 721 has input/output terminals 721a and 721b, and the DC/AC inverter 722 has input/output terminals 722a and 722b. The input/output terminal 721a of the DC/DC converter 721 is connected to the battery system group 711 in the power storage device 710. The input/output terminal 721 b of the DC/DC converter 721 and the input/output terminal 722a of the DC/AC inverter 722 are connected to each other while being connected to an electric power outputter PU1. The input/output terminal 722b of the DC/AC inverter 722 is connected to an electric power outputter PU2 while being connected to another electric power system. Each of the electric power outputters PU1 and PU2 includes an outlet, for example. Various loads, for example, are connected to the electric power outputters PU1 and PU2. The other electric power system includes a commercial power supply or a solar battery, for example. The electric power outputters PU1 and PU2 and the other electric power system are examples of external objects connected to the power supply device.

The controller 712 controls the DC/DC converter 721 and the DC/AC inverter 722 so that a plurality of battery cells 10 included in the battery system group 711 are discharged and charged.

When the battery system group 711 is discharged, the DC/DC converter 721 performs DC/DC conversion of electric power fed from the battery system group 711, and the DC/AC inverter 722 further performs DC/AC conversion thereof.

Electric power obtained by the DC/DC conversion in the DC/DC converter 721 is supplied to the electric power outputter PU1. Electric power obtained by the DC/AC conversion in the DC/AC inverter 722 is supplied to the electric power outputter PU2. DC electric power is output to the external object from the electric power outputter PU1, and AC electric power is output to the external object from the electric power outputter PU2. AC electric power obtained by the conversion in the DC/AC inverter 722 may be supplied to the other electric power system.

The controller 712 performs the following control as an example of control relating to discharge of the plurality of battery cells 10 included in each of the battery systems 500. When the battery system group 711 is discharged, the controller 712 determines whether the discharge of the battery cells 10 is stopped based on the charged capacity of each of the battery cells 10 fed from the corresponding battery ECU 101 (see FIG. 8), and controls the power conversion device 720 based on a determination result. More specifically, when the charged capacity of any one of the plurality of battery cells 10 (see FIG. 18) included in the battery system group 711 becomes smaller than a predetermined threshold value, the controller 712 controls the DC/DC converter 721 and the DC/AC inverter 722 so that the discharge is stopped or the discharging current (or the discharging electric power) is restricted. Thus, each of the battery cells 10 is prevented from being overdischarged.

On the other hand, when the battery system group 711 is charged, the DC/AC inverter 722 performs AC/DC conversion of AC electric power fed from the other electric power system, and the DC/AC converter 721 further performs DC/DC conversion thereof. Electric power is fed from the DC/DC converter 721 to the battery system group 711 so that the plurality of battery cells 10 (FIG. 18) included in the battery system group 711 are charged.

The controller 712 performs the following control as an example of control relating to charge of the plurality of battery cells 10 included in each of the battery systems 500. When the battery system group 711 is charged, the controller 712 determines whether the charge of the battery cells 10 is stopped based on the charged capacity of each of the battery cells 10 fed from the corresponding battery ECU 101 (FIG. 18), and controls the power conversion device 720 based on a determination result. More specifically, when the charged capacity of any one of the plurality of battery cells 10 included in the battery system group 711 becomes larger than a predetermined threshold value, the controller 712 controls the DC/DC converter 721 and the DC/AC inverter 722 so that the charge is stopped or the charging current (or the charging electric power) is restricted. Thus, each of the battery cells 10 is prevented from being overcharged.

(4-2) Effects

The power supply device 700 according to the present embodiment uses the battery system 500 according to the second embodiment. Thus, each of the battery cells 10 can be efficiently cooled. Therefore, the reliability of the power supply device 700 is improved.

(4-3) Modified Example of Power Supply Device

In the power supply device 700 illustrated in FIG. 21, the controller 712 may have a similar function to that of the battery ECU 101 instead of providing each of the battery systems 500 with the battery ECU 101.

If electric power can be supplied between the power supply device 700 and the external object, the power conversion device 720 may have either one of the DC/DC converter 721 and the DC/AC inverter 722. If electric power can be supplied between the power supply device 700 and the external object, the power conversion device 720 need not be provided.

While the plurality of battery systems 500 are provided in the power supply device 700 illustrated in FIG. 21, the present invention is not limited to this. Only one battery system 500 may be provided.

### (5) Another Embodiment

While in the battery module 100 according to the above-mentioned embodiment, both the separators S1 and S2 are used, the present invention is not limited to this. If thermal conduction among the plurality of battery cells 10 does not present a problem, the separator S2 need not be used.

In the battery module 100 according to the above-mentioned embodiment, all the battery cells 10 are connected in series, the present invention is not limited to this. Some or all of the battery cells 10 may be connected in parallel. While all the battery modules 100 are connected in series in the battery system 500 according to the above-mentioned embodiment, the present invention is not limited to this. One or all of the battery modules 100 may be connected in parallel. The number of battery cells 10 in each of the battery modules 100 can be optionally changed.

While the plate-shaped cooling plate 96 is used as a cooling member in the above-mentioned embodiment, the shape of the cooling member is not limited to a plate shape. For example, the shape may be another shape such as a rectangular parallelepiped shape or a frustum shape.

(6) Correspondences Between Constituent Elements in the Claims and Parts in Embodiments

In the following paragraph, non-limiting examples of correspondences between various elements recited in the claims below and those described above with respect to various embodiments of the present invention are explained.

In the embodiments, described above, the battery module 100 is an example of a battery module, the cooling plate 96 is an example of a cooling member, the battery cell 10 is an example of a battery cell, the separator S1 is an example of a thermal conduction member, the bottom surface portions S1b and S1c are examples of a thermal conduction plate, and a side surface portion S1a is an example of a second thermal conduction plate.

The bottom surface portion S1b is an example of a first portion, and the bottom surface portion S1c is an example of a second portion, and the separator S2 is an example of a thermal insulation plate.

The battery system 500 is an example of a battery system, the electric automobile 600 is an example of an electric vehicle and a movable body, the motor 602 is an example of a motor and a power source, the drive wheel 603 is an example of a drive wheel and a driver, the vehicle body 610 is an example of a main body, the power storage device 710 is an example of a power storage device, the controller 712 is an example of a controller, the power supply device 700 is an example of a power supply device, and the power conversion device 720 is an example of a power conversion device.

As each of various elements recited in the claims, various other elements having configurations or functions described in the claims can also be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/we claim:

1. A battery module comprising:
a cooling member having a cooling surface for absorbing heat;
a plurality of battery cells each having a first surface arranged on said cooling surface of said cooling member and having a second surface forming an angle to said first surface; and
a thermal conduction member having a first thermal conduction plate and a second thermal conduction plate forming an angle to said first thermal conduction plate,
wherein said thermal conduction member is arranged so that said first thermal conduction plate directly or indirectly contacts said cooling surface of said cooling member and said second thermal conduction plate contacts said second surface of one of said battery cells.

2. The battery module according to claim 1, wherein
each of said plurality of battery cells has a third surface different from said first and second surfaces, and
said thermal conduction member is arranged so that said second thermal conduction plate further contacts said third surface of the other battery cell adjacent to said one battery cell.

3. The battery module according to claim 1, wherein
said first thermal conduction plate has a first portion projecting toward one surface of said second thermal conduction plate and a second portion projecting toward the other surface of said second thermal conduction plate, and
said thermal conduction member is arranged so that said first portion of said first thermal conduction plate is positioned between said cooling surface of said cooling member and said first surface of said one battery cell.

4. A battery system comprising:
one or a plurality of battery modules,
wherein at least one of said one or plurality of battery modules is the battery module according to claim 1.

5. An electric vehicle comprising:
the battery system according to claim 4;
a motor that is driven by electric power from said battery system; and
a drive wheel that rotates by a torque generated by said motor.

6. A movable body comprising:
the battery system according to claim 4;
a main body;
a power source that converts electric power from said battery system into drive power; and
a driver that moves said main body by the drive power obtained by said power source.

7. A power storage device comprising:
the battery system according to claim 4; and
a controller that performs control relating to discharge or charge of said plurality of battery cells in said battery system.

8. A power supply device that is connectable to an external object, comprising:
the power storage device according to claim 7; and
a power conversion device that is controlled by said controller in said power storage device and converts electric power between said battery system in said power storage device and said external object.
